(19) United States
(12) Patent Application Publication
(10) Pub. No.: US 2016/0267854 A1
(43) Pub. Date: Sep. 15, 2016

(54) DRIVER CIRCUIT WITH REDUCED LEAKAGE

(71) Applicant: QUALCOMM MEMS Technologies, Inc., San Diego, CA (US)

(72) Inventors: Cheonhong Kim, San Diego, CA (US); Heesun Shin, Seoul (KR); Wilhelmus Johannes Robertus Van Lier, San Diego, CA (US); John Hyunchul Hong, San Clemente, CA (US)

(21) Appl. No.: 14/642,248

(22) Filed: Mar. 9, 2015

(51) Int. Cl. G09G 3/34

(52) U.S. Cl. CPC G09G 3/3466; G09G 2320/0214; G09G 2310/04

(57) ABSTRACT

This disclosure provides systems, methods and apparatus for reducing leakage in a driver circuit. In one aspect, the driver circuit may operate in a scanning time and an idle time. The driver circuit may update display elements during the scanning time. During the idle time, inputs to the driver circuit may be configured to be floating to reduce leakage.

### TECHNICAL FIELD

This disclosure relates to electromechanical systems and devices. More specifically, the disclosure relates to a reduced-leakage driver circuit.

### DESCRIPTION OF THE RELATED TECHNOLOGY

Electromechanical systems (EMS) include devices having electrical and mechanical elements, actuators, transducers, sensors, optical components such as mirrors and optical films, and electronics. EMS devices or elements can be manufactured at a variety of scales including, but not limited to, microscales and nanoscales. For example, microelectromechanical systems (MEMS) devices can include structures having sizes ranging from about a micron to hundreds of microns or more. Nanoelectromechanical systems (NEMS) devices can include structures having sizes smaller than a micron including, for example, sizes smaller than several hundred nanometers. Electromechanical elements may be created using deposition, etching, lithography, and/or other micromachining processes that etch away parts of substrates and/or deposited material layers, or that add layers to form electrical and electromechanical devices.

One type of EMS device is called an interferometric modulator (IMOD). The term IMOD or interferometric light modulator refers to a device that selectively absorbs and/or reflects light using the principles of optical interference. In some implementations, an IMOD display element may include a pair of conductive plates, one or both of which may be transparent and/or reflective, wholly or in part, and capable of relative motion upon application of an appropriate electrical signal. For example, one plate may include a stationary layer deposited over, on or supported by a substrate and the other plate may include a reflective membrane separated from the stationary layer by an air gap. The position of one plate in relation to another can change the optical interference of light incident on the IMOD display element. IMOD-based display devices have a wide range of applications, and are anticipated to be used in improving existing products and creating new products, especially those with display capabilities.

In some implementations, a movable element of the IMOD may be moved to a new position from a starting point and under a particular application of voltages to electrodes of the IMOD. Row driver circuits and column driver circuits may provide the voltages to terminals of transistors and/or the electrodes of the IMOD such that the electrodes receive the proper voltages and in a proper sequence such that the movable element is positioned to the new position. However, the transistors used to implement the driver circuits may have a high sub-threshold leakage contributing to static power consumption.

### SUMMARY

The systems, methods and devices of this disclosure each have several innovative aspects, no single one of which is solely responsible for the desirable attributes disclosed herein.

One innovative aspect of the subject matter described in this disclosure can be implemented in a circuit including a driver circuit including driver circuit modules capable of asserting signals to update an array of display units during a first scanning time, and the driver circuit modules being in an idle state during an idle time following the first scanning time; and a controller capable of electrically disconnecting a first set of inputs of the driver circuit modules from one or more sources, the disconnecting based on the driver circuit modules being in the idle state.

In some implementations, the idle time can correspond to a time after the first scanning time and before a second scanning time, the signals de-asserted during the idle time, the signals asserted during the first scanning time and the second scanning time.

In some implementations, each driver circuit module can include a first set of transistors associated with the first set of inputs and a second set of transistors associated with a second set of inputs, the controller capable of electrically disconnecting the first set of inputs from one or more of the sources during the idle state, and electrically connecting the second set of inputs to one or more of the sources during the idle state.

In some implementations, the first set of transistors can be capable of asserting the signals during the first scanning time, and the second set of transistors can be capable of having the signals de-asserted during the idle state.

In some implementations, a first transistor in the first set of transistors can have a first input, a second transistor in the second set of transistors has a second input, the first input and the second input capable of being electrically connected with a first source during the scanning time, the first input of the first transistor capable of being electrically disconnected from the first source in the idle state, and the second input of the second transistor capable of remaining electrically coupled with the first source in the idle state.

In some implementations, the sources can include a clock source and a power supply source.

In some implementations, the first set of inputs can be electrically disconnected from the clock source during the idle state.

In some implementations, each driver circuit module can include a first input switch including a first switch having a first terminal and a second terminal, the first terminal of the first switch coupled to receive an input signal, and a second switch having a first terminal and a second terminal, the first terminal of the second switch coupled with the second terminal of the first switch to define a first feedback node; a first output switch including a third switch having a control terminal coupled with the second terminal of the second switch to define a charge node; a first feedback switch having a first terminal and a control terminal, the first terminal of the first feedback switch coupled with the first feedback node, the control terminal of the first feedback switch coupled with the charge node, the feedback switch configured to charge the first feedback node responsive to a voltage level at the charge node; a second feedback switch having a first terminal, a second terminal, and a control terminal, the control terminal and the first terminal of the second feedback switch coupled with the first feedback node; and a fourth switch having a first terminal and a second terminal, the first terminal of the fourth switch coupled with the charge node, the second terminal of the fourth switch coupled with the second terminal of the second feedback switch to define a second feedback node, the second feedback switch configured to charge the second feedback node responsive to a voltage at the first feedback node.

In some implementations, the driver circuit can include a first driver circuit module and a second driver circuit module, the first driver circuit module coupled with a first clock source, a second clock source, and a third clock source, the second driver circuit module coupled with the first clock source, the second clock source, and a fourth clock source, the clock sources being electrically disconnected from driver circuit modules the during the idle state.

In some implementations, a voltage corresponding to a low state of the first clock source and the second clock source can be lower than a voltage corresponding to a low state of the third clock source.

In some implementations, the circuit can include a display including the array of display units; a processor that is configured to communicate with the display, the processor being configured to process image data; and a memory device that is configured to communicate with the processor.

In some implementations, the circuit can include a controller configured to send at least a portion of the image data to the driver circuit.

In some implementations, the circuit can include an image source module configured to send the image data to the processor, wherein the image source module comprises at least one of a receiver, transceiver, and transmitter.

In some implementations, the circuit can include an input device configured to receive input data and to communicate the input data to the processor.

Another innovative aspect of the subject matter described in this disclosure can be implemented in a system including a driver circuit capable of updating a state of display elements in a display during a first scanning time and maintaining the state of the display elements during an idle time, the idle time occurring after the first scanning time; and a controller capable of determining that the driver circuit is in the idle time, and floating inputs of the driver circuit associated with updating the state of the display elements responsive to the determination that the driver circuit is in the idle time.

In some implementations, the controller can be further capable of having the floating inputs be driven for a second scanning time for updating the state of the display elements in the display.

In some implementations, the inputs of the driver circuit can be associated with maintaining the state of the display elements are driven during the idle time.

In some implementations, the inputs of the driver circuit can be associated with maintaining the state of the display elements are coupled with power supplies during the idle time.

Another innovative aspect of the subject matter described in this disclosure can be implemented in a method including providing, by a driver circuit, signals to update a display during a scanning time; determining, by a controller, that the driver circuit has transitioned from the scanning time to an idle time; and floating, by the controller, inputs to the driver circuit based on the transition from the scanning time to the idle time.

In some implementations, the signals can be asserted to update the display during the scanning time, and the signals are all de-asserted during the idle time.

Details of one or more implementations of the subject matter described in this disclosure are set forth in the accompanying drawings and the description below. Although the examples provided in this disclosure are primarily described in terms of EMS and MEMS-based displays the concepts provided herein may apply to other types of displays such as liquid crystal displays, organic light-emitting diode (“OLED”) displays, and field emission displays. Other features, aspects, and advantages will become apparent from the description, the drawings and the claims. Note that the relative dimensions of the following figures may not be drawn to scale.

### BRIEF DESCRIPTION OF THE DRAWINGS

FIG. 1 is an isometric view illustration depicting two adjacent interferometric modulator (IMOD) display elements in a series or array of display elements of an IMOD display device.

FIG. 2 is a system block diagram illustrating an electronic device incorporating an IMOD-based display including a three element by three element array of IMOD display elements.

FIGS. 3A and 3B are schematic exploded partial perspective views of a portion of an electromechanical systems (EMS) package including an array of EMS elements and a backplate.

FIG. 4 is an example of a system block diagram illustrating an electronic device incorporating an IMOD-based display.

FIG. 5 is a circuit schematic of an example of a three-terminal IMOD.

FIG. 6A is a circuit schematic of a driver circuit module.

FIG. 6B is an illustration of example leakage currents of the driver circuit module of FIG. 6A.

FIG. 7 is an example of a system block diagram illustrating driver circuit modules.

FIG. 8 is an example of a system block diagram illustrating driver circuit modules coupled with transistors associated with the three-terminal IMOD of FIG. 5.

FIGS. 9A and 9B are illustrations of examples of scanning time and idle time.

FIG. 9C is an illustration of another example of scanning time and idle time.

FIG. 10 is an example of a system block diagram of a driver circuit module with gated inputs.

FIG. 11 is an example of a system block diagram of switches providing gated inputs to a driver circuit module.

FIG. 12 is an example of a system block diagram of two driver circuit modules.

FIG. 13 is an example of a timing diagram for the driver circuit modules of FIG. 13.

FIG. 14 is a circuit schematic of another example of a driver circuit module.

FIG. 15 is an example of a timing diagram for the driver circuit module of FIG. 15.

FIG. 16 is an illustration of a transfer curve for I_{d} (drain current) vs. V_{gs} (gate-to-source voltage) for an exemplary NMOS transistor.

FIG. 17 is a flow diagram illustrating a method for floating inputs of a driver circuit module.

FIGS. 18A and 18B are system block diagrams illustrating a display device that includes a plurality of IMOD display elements.

Like reference numbers and designations in the various drawings indicate like elements.

### DETAILED DESCRIPTION

The following description is directed to certain implementations for the purposes of describing the innovative aspects of this disclosure. However, a person having ordinary skill in the art will readily recognize that the teachings herein can be applied in a multitude of different ways. The described implementations may be implemented in any device, apparatus, or system that can be configured to display an image, whether in motion (such as video) or stationary (such as still images), and whether textual, graphical or pictorial. More particularly, it is contemplated that the described implementations may be included in or associated with a variety of electronic devices such as, but not limited to: mobile telephones, multimedia Internet enabled cellular telephones, mobile television receivers, wireless devices, smartphones, Bluetooth® devices, personal data assistants (PDAs), wireless electronic mail receivers, hand-held or portable computers, netbooks, notebooks, smartbooks, tablets, printers, copiers, scanners, facsimile devices, global positioning system (GPS) receivers/navigators, cameras, digital media players (such as MP3 players), camcorders, game consoles, wrist watches, clocks, calculators, television monitors, flat panel displays, electronic reading devices (e.g., e-readers), computer monitors, auto displays (including odometer and speedometer displays, etc.), cockpit controls and/or displays, camera view displays (such as the display of a rear view camera in a vehicle), electronic photographs, electronic billboards or signs, projectors, architectural structures, microwaves, refrigerators, stereo systems, cassette recorders or players, DVD players, CD players, VCRs, radios, portable memory chips, washers, dryers, washer/dryers, parking meters, packaging (such as in electromechanical systems (EMS) applications including microelectromechanical systems (MEMS) applications, as well as non-EMS applications), aesthetic structures (such as display of images on a piece of jewelry or clothing) and a variety of EMS devices. The teachings herein also can be used in non-display applications such as, but not limited to, electronic switching devices, radio frequency filters, sensors, accelerometers, gyroscopes, motion-sensing devices, magnetometers, inertial components for consumer electronics, parts of consumer electronics products, varactors, liquid crystal devices, electrophoretic devices, drive schemes, manufacturing processes and electronic test equipment. Thus, the teachings are not intended to be limited to the implementations depicted solely in the Figures, but instead have wide applicability as will be readily apparent to one having ordinary skill in the art.

Active matrix flat panel displays such as active matrix liquid crystal displays, organic light emission displays, and interferometric modulator (IMOD) displays may use thin film transistors (TFTs) on glass substrates. The TFTs may be used to implement driver circuits for addressing display elements.

Amorphous oxide semiconductor TFTs, such as indium gallium zinc oxide (IGZO) TFTs, may be used to replace amorphous silicon and low temperature and polysilicon TFTs. In some implementations, the oxide semiconductor layer can include one or more of indium (In), gallium (Ga), zinc (Zn), hafnium (Hf), and tin (Sn). However, IGZO TFTs have a high sub-threshold leakage current (e.g., an unwanted drain current when the transistor gate voltage is zero). Preferably, sub-threshold leakage current should be reduced to ensure a circuit operates properly and lower static power consumption.

Some implementations of the subject matter described in this disclosure reduce leakage current in a driver circuit module. Leakage contributing to static power consumption may be reduced by floating inputs of the driver circuit following a scanning time of the display when the driver circuit module is idle. Additionally, leakage may be reduced by employing a power supply scheme used to bias each transistor of the driver circuit. Moreover, an implementation of feedback transistors can also be used to reduce leakage.

Particular implementations of the subject matter described in this disclosure can be implemented to realize one or more of the following potential advantages. Reducing static power consumption may lower power usage and, for example, increase the battery life of devices including display devices such as tablets, laptops, mobile phones, e-book readers, and wearable devices (e.g., smart watches). Lower power consumption also may enable an “always-on” feature where the display is refreshed at a very low frame rate (e.g., 1 Hz, 0.1 Hz, or less).

An example of a suitable EMS or MEMS device or apparatus, to which the described implementations may apply, is a reflective display device. Reflective display devices can incorporate interferometric modulator (IMOD) display elements that can be implemented to selectively absorb and/or reflect light incident thereon using principles of optical interference. IMOD display elements can include a partial optical absorber, a reflector that is movable with respect to the absorber, and an optical resonant cavity defined between the absorber and the reflector. In some implementations, the reflector can be moved to two or more different positions, which can change the size of the optical resonant cavity and thereby affect the reflectance of the IMOD. The reflectance spectra of IMOD display elements can create fairly broad spectral bands that can be shifted across the visible wavelengths to generate different colors. The position of the spectral band can be adjusted by changing the thickness of the optical resonant cavity. One way of changing the optical resonant cavity is by changing the position of the reflector with respect to the absorber.

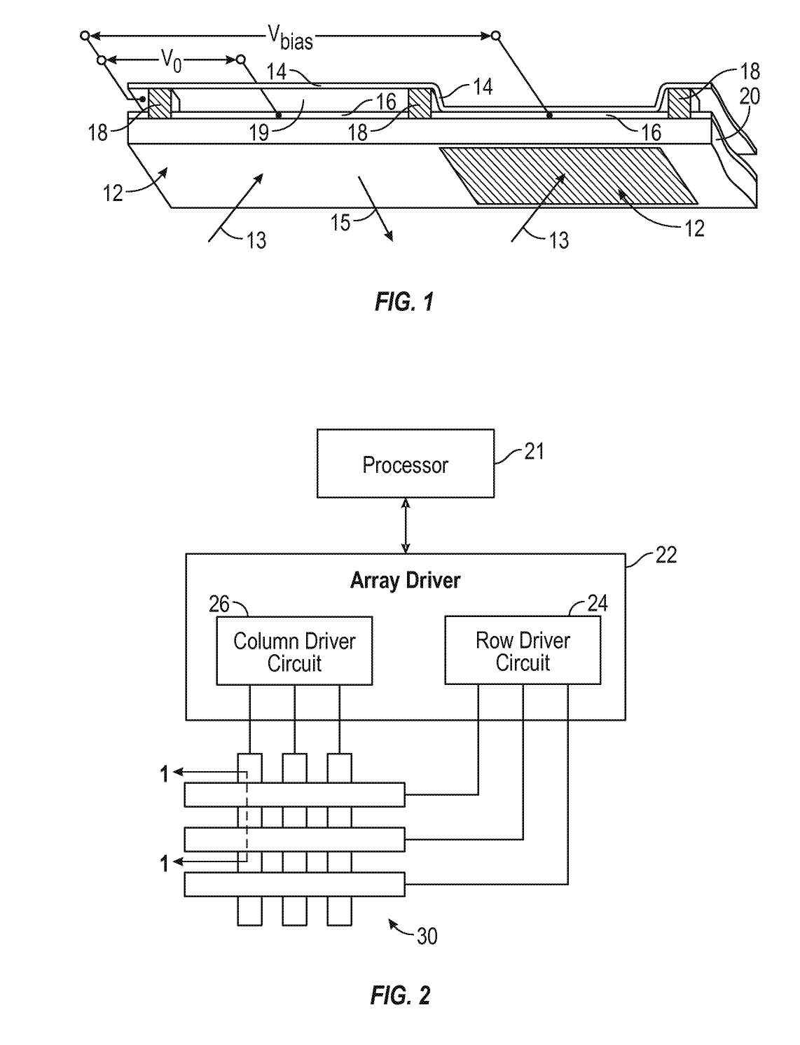

FIG. 1 is an isometric view illustration depicting two adjacent interferometric modulator (IMOD) display elements in a series or array of display elements of an IMOD display device. The IMOD display device includes one or more interferometric EMS, such as MEMS, display elements. In these devices, the interferometric MEMS display elements can be configured in either a bright or dark state. In the bright (“relaxed,” “open” or “on,” etc.) state, the display element reflects a large portion of incident visible light. Conversely, in the dark (“actuated,” “closed” or “off,” etc.) state, the display element reflects little incident visible light. MEMS display elements can be configured to reflect predominantly at particular wavelengths of light allowing for a color display in addition to black and white. In some implementations, by using multiple display elements, different intensities of color primaries and shades of gray can be achieved.

The IMOD display device can include an array of IMOD display elements which may be arranged in rows and columns. Each display element in the array can include at least a pair of reflective and semi-reflective layers, such as a movable reflective layer (i.e., a movable layer, also referred to as a mechanical layer) and a fixed partially reflective layer (i.e., a stationary layer), positioned at a variable and controllable distance from each other to form an air gap (also referred to as an optical gap, cavity or optical resonant cavity). The movable reflective layer may be moved between at least two positions. For example, in a first position, i.e., a relaxed position, the movable reflective layer can be positioned at a distance from the fixed partially reflective layer. In a second position, i.e., an actuated position, the movable reflective layer can be positioned more closely to the partially reflective layer. Incident light that reflects from the two layers can interfere constructively and/or destructively depending on the position of the movable reflective layer and the wavelength(s) of the incident light, producing either an overall reflective or non-reflective state for each display element. In some implementations, the display element may be in a reflective state when unactuated, reflecting light within the visible spectrum, and may be in a dark state when actuated, absorbing and/or destructively interfering light within the visible range. In some other implementations, however, an IMOD display element may be in a dark state when unactuated, and in a reflective state when actuated. In some implementations, the introduction of an applied voltage can drive the display elements to change states. In some other implementations, an applied charge can drive the display elements to change states.

The depicted portion of the array in FIG. 1 includes two adjacent interferometric MEMS display elements in the form of IMOD display elements 12. In the display element 12 on the right (as illustrated), the movable reflective layer 14 is illustrated in an actuated position near, adjacent or touching the optical stack 16. The voltage V_{bias} applied across the display element 12 on the right is sufficient to move and also maintain the movable reflective layer 14 in the actuated position. In the display element 12 on the left (as illustrated), a movable reflective layer 14 is illustrated in a relaxed position at a distance (which may be predetermined based on design parameters) from an optical stack 16, which includes a partially reflective layer. The voltage V₀ applied across the display element 12 on the left is insufficient to cause actuation of the movable reflective layer 14 to an actuated position such as that of the display element 12 on the right.

In FIG. 1, the reflective properties of IMOD display elements 12 are generally illustrated with arrows indicating light 13 incident upon the IMOD display elements 12, and light 15 reflecting from the display element 12 on the left. Most of the light 13 incident upon the display elements 12 may be transmitted through the transparent substrate 20, toward the optical stack 16. A portion of the light incident upon the optical stack 16 may be transmitted through the partially reflective layer of the optical stack 16, and a portion will be reflected back through the transparent substrate 20. The portion of light 13 that is transmitted through the optical stack 16 may be reflected from the movable reflective layer 14, back toward (and through) the transparent substrate 20. Interference (constructive and/or destructive) between the light reflected from the partially reflective layer of the optical stack 16 and the light reflected from the movable reflective layer 14 will determine in part the intensity of wavelength(s) of light 15 reflected from the display element 12 on the viewing or substrate side of the device. In some implementations, the transparent substrate 20 can be a glass substrate (sometimes referred to as a glass plate or panel). The glass substrate may be or include, for example, a borosilicate glass, a soda lime glass, quartz, Pyrex, or other suitable glass material. In some implementations, the glass substrate may have a thickness of 0.3, 0.5 or 0.7 millimeters, although in some implementations the glass substrate can be thicker (such as tens of millimeters) or thinner (such as less than 0.3 millimeters). In some implementations, a non-glass substrate can be used, such as a polycarbonate, acrylic, polyethylene terephthalate (PET) or polyether ether ketone (PEEK) substrate. In such an implementation, the non-glass substrate will likely have a thickness of less than 0.7 millimeters, although the substrate may be thicker depending on the design considerations. In some implementations, a non-transparent substrate, such as a metal foil or stainless steel-based substrate can be used. For example, a reverse-IMOD-based display, which includes a fixed reflective layer and a movable layer which is partially transmissive and partially reflective, may be configured to be viewed from the opposite side of a substrate as the display elements 12 of FIG. 1 and may be supported by a non-transparent substrate.

The optical stack 16 can include a single layer or several layers. The layer(s) can include one or more of an electrode layer, a partially reflective and partially transmissive layer, and a transparent dielectric layer. In some implementations, the optical stack 16 is electrically conductive, partially transparent and partially reflective, and may be fabricated, for example, by depositing one or more of the above layers onto a transparent substrate 20. The electrode layer can be formed from a variety of materials, such as various metals, for example indium tin oxide (ITO). The partially reflective layer can be formed from a variety of materials that are partially reflective, such as various metals (e.g., chromium and/or molybdenum), semiconductors, and dielectrics. The partially reflective layer can be formed of one or more layers of materials, and each of the layers can be formed of a single material or a combination of materials. In some implementations, certain portions of the optical stack 16 can include a single semi-transparent thickness of metal or semiconductor which serves as both a partial optical absorber and electrical conductor, while different, electrically more conductive layers or portions (e.g., of the optical stack 16 or of other structures of the display element) can serve to bus signals between IMOD display elements. The optical stack 16 also can include one or more insulating or dielectric layers covering one or more conductive layers or an electrically conductive/partially absorptive layer.

In some implementations, at least some of the layer(s) of the optical stack 16 can be patterned into parallel strips, and may form row electrodes in a display device as described further below. As will be understood by one having ordinary skill in the art, the term “patterned” is used herein to refer to masking as well as etching processes. In some implementations, a highly conductive and reflective material, such as aluminum (Al), may be used for the movable reflective layer 14, and these strips may form column electrodes in a display device. The movable reflective layer 14 may be formed as a series of parallel strips of a deposited metal layer or layers (orthogonal to the row electrodes of the optical stack 16) to form columns deposited on top of supports, such as the illustrated posts 18, and an intervening sacrificial material located between the posts 18. When the sacrificial material is etched away, a defined gap 19, or optical cavity, can be formed between the movable reflective layer 14 and the optical stack 16. In some implementations, the spacing between posts 18 may be approximately 1-1000 μm, while the gap 19 may be approximately less than 10,000 Angstroms (Å).

In some implementations, each IMOD display element, whether in the actuated or relaxed state, can be considered as a capacitor formed by the fixed and moving reflective layers. When no voltage is applied, the movable reflective layer 14 remains in a mechanically relaxed state, as illustrated by the display element 12 on the left in FIG. 1, with the gap 19 between the movable reflective layer 14 and optical stack 16. However, when a potential difference, i.e., a voltage, is applied to at least one of a selected row and column, the capacitor formed at the intersection of the row and column electrodes at the corresponding display element becomes charged, and electrostatic forces pull the electrodes together. If the applied voltage exceeds a threshold, the movable reflective layer 14 can deform and move near or against the optical stack 16. A dielectric layer (not shown) within the optical stack 16 may prevent shorting and control the separation distance between the layers 14 and 16, as illustrated by the actuated display element 12 on the right in FIG. 1. The behavior can be the same regardless of the polarity of the applied potential difference. Though a series of display elements in an array may be referred to in some instances as “rows” or “columns,” a person having ordinary skill in the art will readily understand that referring to one direction as a “row” and another as a “column” is arbitrary. Restated, in some orientations, the rows can be considered columns, and the columns considered to be rows. In some implementations, the rows may be referred to as “common” lines and the columns may be referred to as “segment” lines, or vice versa. Furthermore, the display elements may be evenly arranged in orthogonal rows and columns (an “array”), or arranged in non-linear configurations, for example, having certain positional offsets with respect to one another (a “mosaic”). The terms “array” and “mosaic” may refer to either configuration. Thus, although the display is referred to as including an “array” or “mosaic,” the elements themselves need not be arranged orthogonally to one another, or disposed in an even distribution, in any instance, but may include arrangements having asymmetric shapes and unevenly distributed elements.

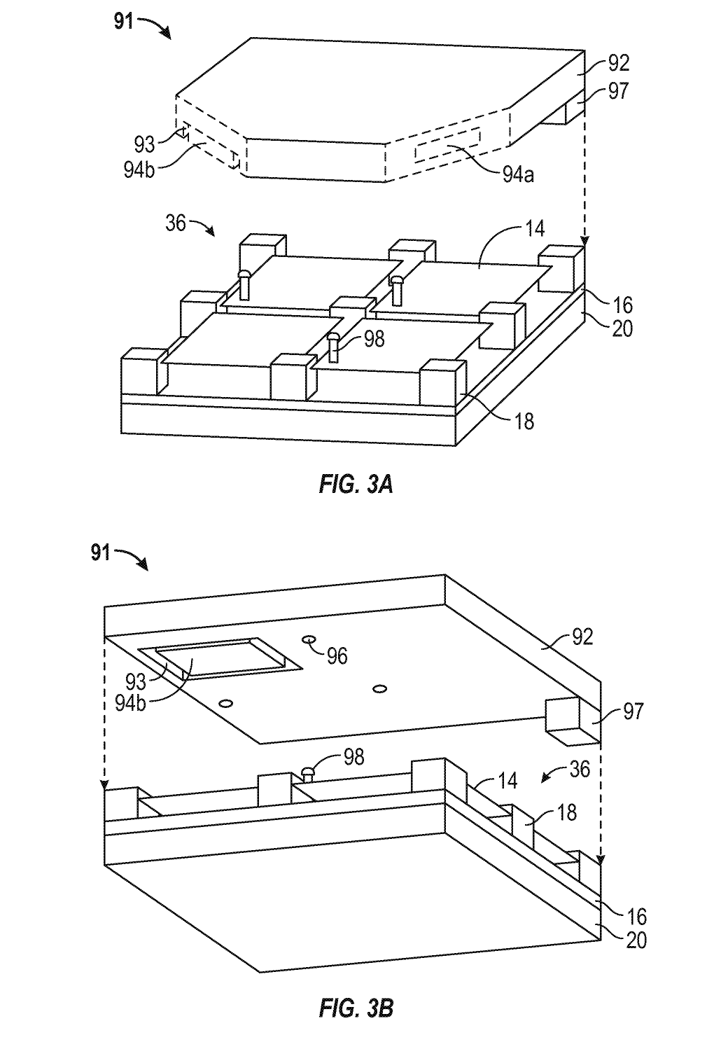

FIG. 2 is a system block diagram illustrating an electronic device incorporating an IMOD-based display including a three element by three element array of IMOD display elements. The electronic device includes a processor 21 that may be configured to execute one or more software modules. In addition to executing an operating system, the processor 21 may be configured to execute one or more software applications, including a web browser, a telephone application, an email program, or any other software application.

The processor 21 can be configured to communicate with an array driver 22. The array driver 22 can include a row driver circuit 24 and a column driver circuit 26 that provide signals to, for example a display array or panel 30. The cross section of the IMOD display device illustrated in FIG. 1 is shown by the lines 1-1 in FIG. 2. Although FIG. 2 illustrates a 3×3 array of IMOD display elements for the sake of clarity, the display array 30 may contain a very large number of IMOD display elements, and may have a different number of IMOD display elements in rows than in columns, and vice versa.

In some implementations, the packaging of an EMS component or device, such as an IMOD-based display, can include a backplate (alternatively referred to as a backplane, back glass or recessed glass) which can be configured to protect the EMS components from damage (such as from mechanical interference or potentially damaging substances). The backplate also can provide structural support for a wide range of components, including but not limited to driver circuitry, processors, memory, interconnect arrays, vapor barriers, product housing, and the like. In some implementations, the use of a backplate can facilitate integration of components and thereby reduce the volume, weight, and/or manufacturing costs of a portable electronic device.

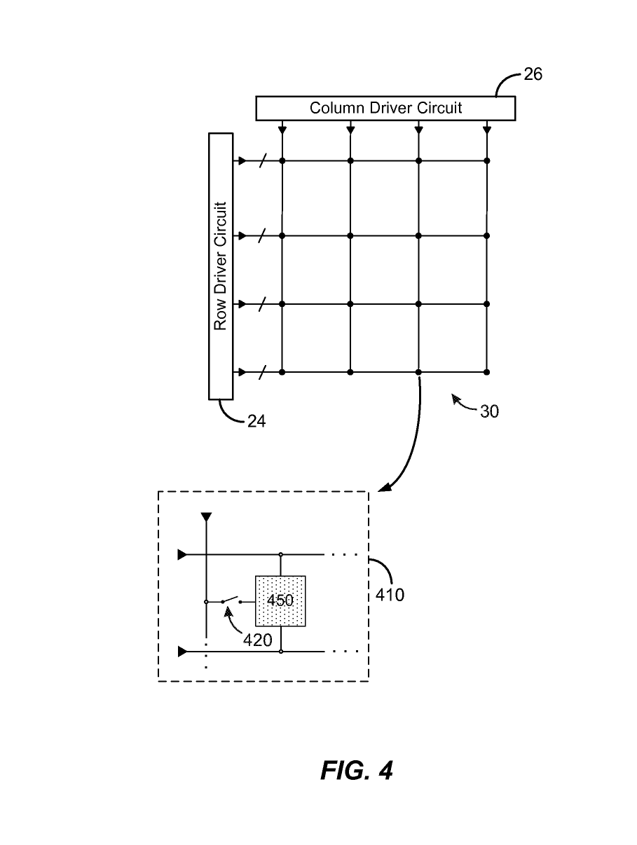

FIGS. 3A and 3B are schematic exploded partial perspective views of a portion of an EMS package 91 including an array 36 of EMS elements and a backplate 92. FIG. 3A is shown with two corners of the backplate 92 cut away to better illustrate certain portions of the backplate 92, while FIG. 3B is shown without the corners cut away. The EMS array 36 can include a substrate 20, support posts 18, and a movable layer 14. In some implementations, the EMS array 36 can include an array of IMOD display elements with one or more optical stack portions 16 on a transparent substrate, and the movable layer 14 can be implemented as a movable reflective layer.

The backplate 92 can be essentially planar or can have at least one contoured surface (e.g., the backplate 92 can be formed with recesses and/or protrusions). The backplate 92 may be made of any suitable material, whether transparent or opaque, conductive or insulating. Suitable materials for the backplate 92 include, but are not limited to, glass, plastic, ceramics, polymers, laminates, metals, metal foils, Kovar and plated Kovar.

As shown in FIGS. 3A and 3B, the backplate 92 can include one or more backplate components 94a and 94b, which can be partially or wholly embedded in the backplate 92. As can be seen in FIG. 3A, backplate component 94a is embedded in the backplate 92. As can be seen in FIGS. 3A and 3B, backplate component 94b is disposed within a recess 93 formed in a surface of the backplate 92. In some implementations, the backplate components 94a and/or 94b can protrude from a surface of the backplate 92. Although backplate component 94b is disposed on the side of the backplate 92 facing the substrate 20, in other implementations, the backplate components can be disposed on the opposite side of the backplate 92.

The backplate components 94a and/or 94b can include one or more active or passive electrical components, such as transistors, capacitors, inductors, resistors, diodes, switches, and/or integrated circuits (ICs) such as a packaged, standard or discrete IC. Other examples of backplate components that can be used in various implementations include antennas, batteries, and sensors such as electrical, touch, optical, or chemical sensors, or thin-film deposited devices.

In some implementations, the backplate components 94a and/or 94b can be in electrical communication with portions of the EMS array 36. Conductive structures such as traces, bumps, posts, or vias may be formed on one or both of the backplate 92 or the substrate 20 and may contact one another or other conductive components to form electrical connections between the EMS array 36 and the backplate components 94a and/or 94b. For example, FIG. 3B includes one or more conductive vias 96 on the backplate 92 which can be aligned with electrical contacts 98 extending upward from the movable layers 14 within the EMS array 36. In some implementations, the backplate 92 also can include one or more insulating layers that electrically insulate the backplate components 94a and/or 94b from other components of the EMS array 36. In some implementations in which the backplate 92 is formed from vapor-permeable materials, an interior surface of backplate 92 can be coated with a vapor barrier (not shown).

The backplate components 94a and 94b can include one or more desiccants which act to absorb any moisture that may enter the EMS package 91. In some implementations, a desiccant (or other moisture absorbing materials, such as a getter) may be provided separately from any other backplate components, for example as a sheet that is mounted to the backplate 92 (or in a recess formed therein) with adhesive. Alternatively, the desiccant may be integrated into the backplate 92. In some other implementations, the desiccant may be applied directly or indirectly over other backplate components, for example by spray-coating, screen printing, or any other suitable method.

In some implementations, the EMS array 36 and/or the backplate 92 can include mechanical standoffs 97 to maintain a distance between the backplate components and the display elements and thereby prevent mechanical interference between those components. In the implementation illustrated in FIGS. 3A and 3B, the mechanical standoffs 97 are formed as posts protruding from the backplate 92 in alignment with the support posts 18 of the EMS array 36. Alternatively or in addition, mechanical standoffs, such as rails or posts, can be provided along the edges of the EMS package 91.

Although not illustrated in FIGS. 3A and 3B, a seal can be provided which partially or completely encircles the EMS array 36. Together with the backplate 92 and the substrate 20, the seal can form a protective cavity enclosing the EMS array 36. The seal may be a semi-hermetic seal, such as a conventional epoxy-based adhesive. In some other implementations, the seal may be a hermetic seal, such as a thin film metal weld or a glass frit. In some other implementations, the seal may include polyisobutylene (PIB), polyurethane, liquid spin-on glass, solder, polymers, plastics, or other materials. In some implementations, a reinforced sealant can be used to form mechanical standoffs.

In alternate implementations, a seal ring may include an extension of either one or both of the backplate 92 or the substrate 20. For example, the seal ring may include a mechanical extension (not shown) of the backplate 92. In some implementations, the seal ring may include a separate member, such as an O-ring or other annular member.

In some implementations, the EMS array 36 and the backplate 92 are separately formed before being attached or coupled together. For example, the edge of the substrate 20 can be attached and sealed to the edge of the backplate 92 as discussed above. Alternatively, the EMS array 36 and the backplate 92 can be formed and joined together as the EMS package 91. In some other implementations, the EMS package 91 can be fabricated in any other suitable manner, such as by forming components of the backplate 92 over the EMS array 36 by deposition.

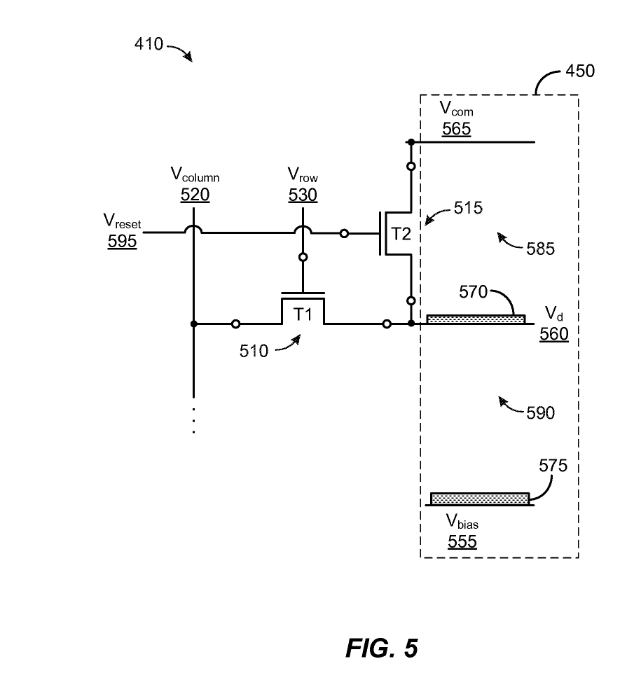

FIG. 4 is an example of a system block diagram illustrating an electronic device incorporating an IMOD-based display. FIG. 4 depicts an implementation of row driver circuit 24 and column driver circuit 26 (i.e., circuits of array driver 22 of FIG. 2) that provide signals to display array or panel 30, as previously discussed.

The implementation of display module 410 in display array 30 may include a variety of different designs. As an example, display module 410 in the fourth row includes switch 420 and display unit 450. Display module 410 may be provided a row signal, reset signal, and a bias signal from row driver circuit 24. Display module 410 may also be provided a column, or data signal and a common signal from column driver circuit 26. In some implementations, display unit 450 may be coupled with switch 420, such as a transistor with its gate coupled to the row signal and its drain coupled with the column signal. Each display unit 450 may include an IMOD display element as a pixel.

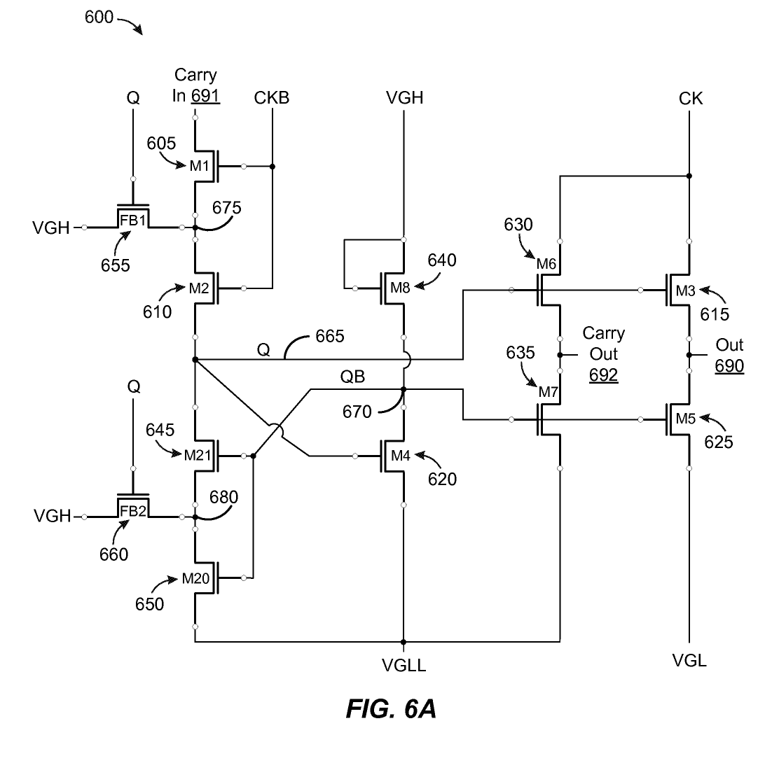

Some IMODs are three-terminal devices that use a variety of signals. FIG. 5 is a circuit schematic of an example of a three-terminal IMOD. In the example of FIG. 5, display module 410 includes display unit 450 (e.g., an IMOD). The circuit of FIG. 5 also includes switch 420 of FIG. 4 implemented as an n-type metal-oxide-semiconductor (NMOS) transistor T1 510. The gate of transistor T1 510 is coupled to V_{row} 530 (i.e., a control terminal of transistor T1 510 is coupled to V_{row} 530 providing a row select signal), which may be provided a voltage by row driver circuit 24 of FIG. 4. Transistor T1 510 is also coupled to V_{column} 520, which may be provided a voltage by column driver circuit 26 of FIG. 4. If V_{row} 530 is at a voltage to turn transistor T1 510 on, the voltage on V_{column} 520 may be applied to V_{d} electrode 560. The circuit of FIG. 5 also includes another switch implemented as an NMOS transistor T2 515. The gate (or control) of transistor T2 515 is coupled with Vᵣₑₛₑₜ 595. The other two terminals of transistor T2 515 are coupled with V_{com} electrode 565 and V_{d} electrode 560. When transistor T2 515 is turned on (e.g., by a voltage of a reset signal on Vᵣₑₛₑₜ 595 applied to the gate of transistor T2 515), V_{com} electrode 565 and V_{d} electrode 560 may be shorted together.

In FIG. 5, display unit 450 is a three-terminal IMOD including three terminals or electrodes: V_{bias} electrode 555, V_{d} electrode 560, and V_{com} electrode 565. Display unit 450 may also include movable element 570 and dielectric 575. Movable element 570 may include a mirror, as previously discussed. Movable element 570 may be coupled with V_{d} electrode 560. Additionally, air gap 590 may be between V_{bias} electrode 555 and V_{d} electrode 560. Air gap 585 may be between V_{d} electrode 560 and V_{com} electrode 565. In some implementations, display unit 450 may also include one or more capacitors. For example, one or more capacitors can be coupled between V_{d} electrode 560 and V_{com} electrode 565 and/or between V_{bias} electrode 555 and V_{d} electrode 560.

Movable element 570 can be positioned at points, or locations, between V_{bias} electrode 555 and V_{com} electrode 565 to provide light at a specific wavelength at each specific point. In particular, voltages applied to V_{bias} electrode 555, V_{d} electrode 560, and V_{com} electrode 565 may determine the position of movable element 570. Voltages for Vᵣₑₛₑₜ 595, V_{column} 520, V_{row} 530, V_{com} electrode 565, and V_{bias} electrode 555 may be provided by driver circuits such as row driver circuit 24 and column driver circuit 26. In some implementations, V_{com} electrode 565 may be coupled to ground rather than driven by row driver circuit 24 or column driver circuit 26.

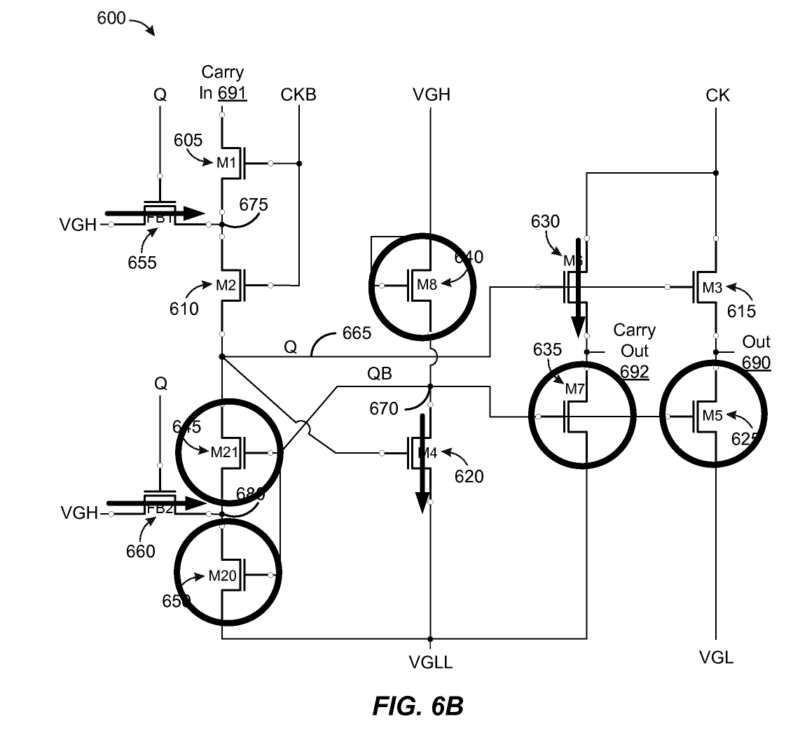

FIG. 6A is a circuit schematic of a driver circuit module. Driver circuit module 600 in FIG. 6A may be used to provide an output 690, which may be used to provide V_{row} 530 or Vᵣₑₛₑₜ 595 for display module 410 in FIG. 5. U.S. patent application Publication Ser. No. 13/909,839, titled REDUCING FLOATING NODE LEAKAGE CURRENT WITH A FEEDBACK TRANSISTOR, by Kim et al., filed on Jun. 4, 2013, discloses driver circuit module 600 in more detail, and is hereby incorporated by reference in its entirety and for all purposes.

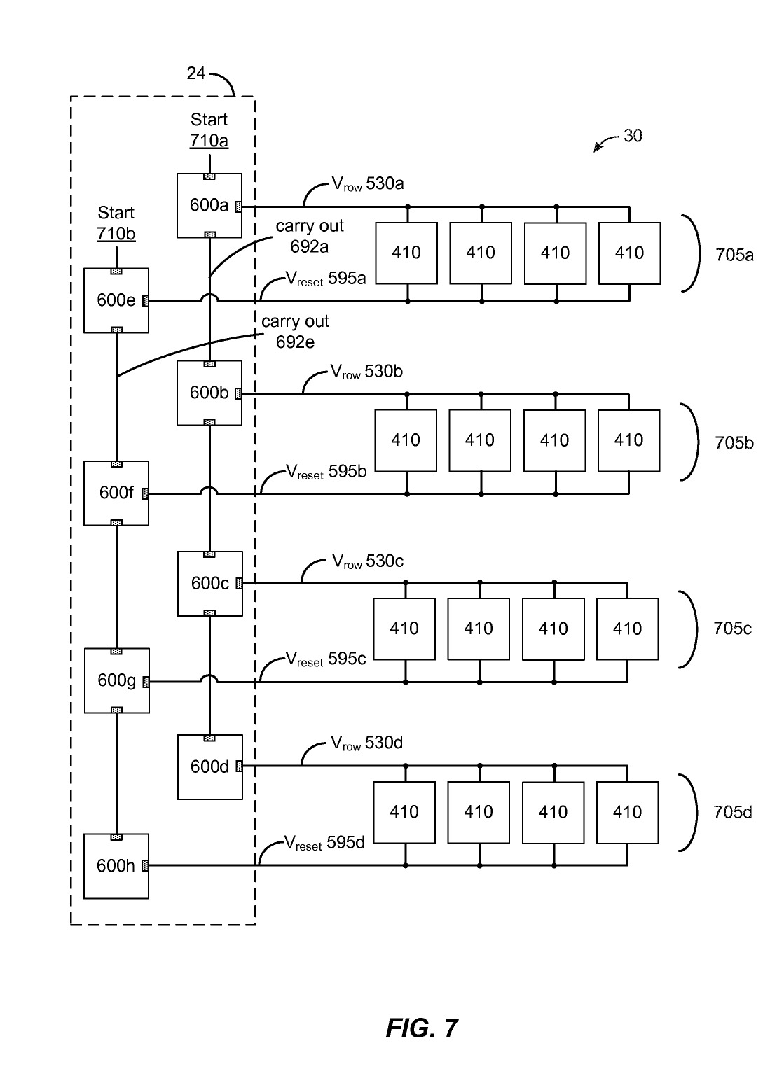

Driver circuit module 600 may operate with other driver circuit modules to provide signals to V_{row} 530 or Vᵣₑₛₑₜ 595 at output 690 for a display 30 of display modules 410. FIG. 7 is an example of a system block diagram illustrating driver circuit modules. In FIG. 7, driver circuit modules 600a-d may provide V_{row} 530a-d at their respective outputs 690 for each corresponding row 705a-d as a row select driver of row driver 24. For example, driver circuit module 600a may provide V_{row} 530a to each display module 410 (i.e., a voltage to be applied to the gate of transistor T1 510 in FIG. 5) in row 705a. Additionally, carry out 692a may be generated by driver circuit module 600a and provided as the carry in 691 input to driver circuit module 600b. Carry out 692 may follow the same pattern as output 690 (i.e., when output 690 is asserted by going to a high voltage from a low voltage, carry out 692 also is asserted by going to the high voltage), but with a lower low voltage than output 690. A previous driver circuit module's carry out 692 may be provided as the subsequent driver circuit module's carry in 691.

Likewise, driver circuit modules 600e-h may provide Vᵣₑₛₑₜ 595a-d (at the respective outputs 690) for each corresponding row 705a-d as a reset select driver of row driver 24. For example, driver circuit module 600e may provide Vᵣₑₛₑₜ 595a to each display module 410 (i.e., a voltage to be applied to the gate of transistor T2 515 in FIG. 5) in row 705a. Additionally, a similar carry in and carry out scheme as with driver circuit modules 600a-d may also be implemented.

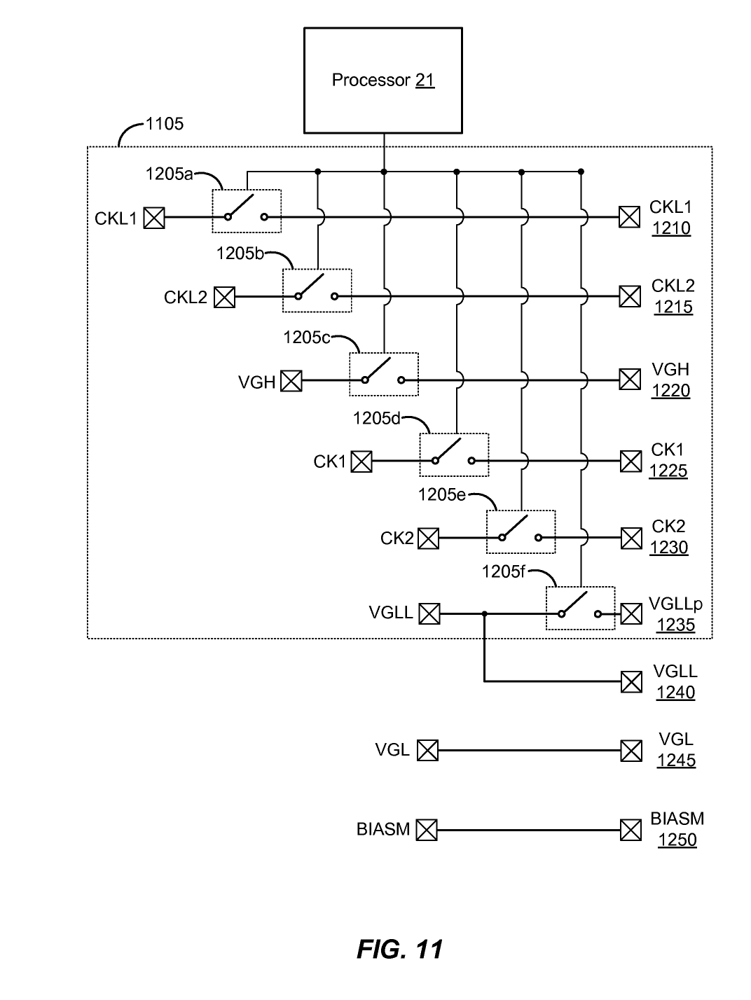

Start 710a and 710b may be provided, for example, by processor 21 (of FIG. 11) and may be provided to the carry in 691 inputs of display module drivers 600a and 600e (i.e., the first driver circuit modules in the row select driver and reset select driver).

In some implementations, the row select driver (i.e., driver circuit modules 600a-d) and the reset select driver (i.e., driver circuit modules 600e-h) in FIG. 7 drive even-numbered rows (e.g., row 705a is a first row in display 30, row 705b is a third row in display 30, etc.), and another row select driver and reset select driver may drive odd-numbered rows (e.g., a row in between row 705a and row 705b may be the second row in display 30).

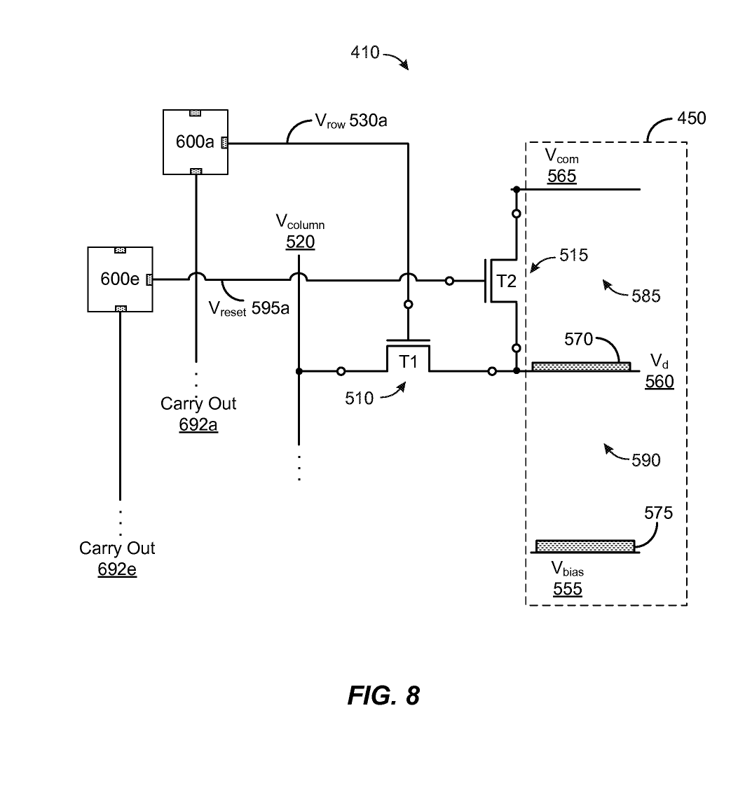

FIG. 8 is an example of a system block diagram illustrating driver circuit modules coupled with transistors associated with the three-terminal IMOD of FIG. 5. In FIG. 8, driver circuit module 600a is shown to be providing V_{row} 530a (at its output 690) to a gate of transistor T1 510 of a display module 410 in row 705a and driver circuit module 600e is shown to be providing Vᵣₑₛₑₜ 595a (at its output 690) to a gate of transistor T2 515 of the same display module 410. Carry out 692a and carry out 692e may be provided to driver circuit modules 600b and 600f at their carry in 691 inputs, respectively.

In some displays, a scanning time may be when display elements of the display are updated. For example, driver circuit modules 600a-d in FIG. 7 implementing a row select driver may assert V_{row} 530a-d (e.g., by providing a voltage VGH provided by CK at output 690 in FIG. 6A) one-at-a-time in a row-by-row fashion to turn on transistors T1 510 in each display module 410 in a row until every row of display modules 410 has been updated (e.g., by positioning the movable elements 570) and providing the proper colors for the image to be displayed corresponding to the frame. When a second and subsequent image corresponding to a second frame is to be displayed, the process may repeat to provide new colors. When not asserted, output 690 may be pulled to VGL by transistor M5 625 to turn off transistors T1 510 in each display module 410 in a row. Likewise, driver circuit modules 600e-h implementing a reset select driver may assert Vᵣₑₛₑₜ 595a-d one-at-a-time in a row-by-row fashion to turn on transistors T2 515 in each display module 410 in a row until every row of display modules 410 has been updated. As a result, each row may have every movable element 570 of display units 450 of display modules 410 be reset and then positioned row-by-row. U.S. patent application Publication Ser. No. 14/500,321, titled SYSTEMS, DEVICES AND METHODS FOR DRIVING AN ANALOG INTERFEROMETRIC MODULATOR UTILIZING DC COMMON WITH RESET, by Van Lier et al., filed on Sep. 29, 2014, discloses a reset and drive scheme in more detail, and is hereby incorporated by reference in its entirety and for all purposes.

Generally, how often the scanning is performed from frame-to-frame is based on a refresh rate of the display. Different refresh rates may allow for a scanning time (i.e., the duration that the scanning is performed within the time period of the frame), but a varying amount of idle time (i.e., in an idle state where the outputs or signals are not asserted such that the states or positions of movable elements 570 are maintained or unchanged). Idle time may be the time following scanning time, but before movable elements 570 of display modules 410 should next be updated for the next frame.

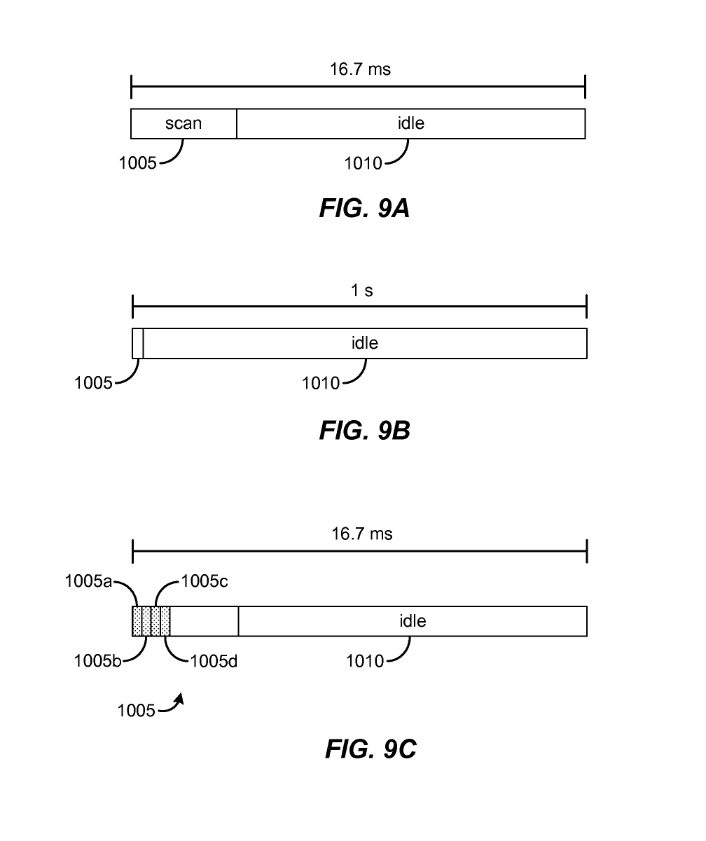

FIGS. 9A and 9B are illustrations of examples of scanning time and idle time. In FIG. 9A, a 60 hertz (Hz) refresh rate may have a 16.7 millisecond (ms) time for frames, and therefore, 16.7 ms between the start of scanning times of consecutive frames. Scanning time 1005 may be when the display pixels are scanned row-by-row. Idle time 1010 may be following the final operation, but before the next scanning time. In FIG. 9B, a 1 Hz refresh rate may have a 1 second (s) time between the start of scanning times. Scanning time 1005 in FIG. 9B may be for a similar duration as scanning time 1005 in FIG. 9A, but idle time 1010 in FIG. 9B may be longer in duration than idle time 1010 in FIG. 9A due to a 1 Hz refresh rate having a longer time between scanning times than a 60 Hz refresh rate. In some scenarios, a 1 Hz refresh rate may allow for an “always-on” mode for a display.

Accordingly, scanning time 1005 may be the time when driver circuit modules 600a-d assert V_{row} 530a-d and when driver circuit modules 600e-h assert Vᵣₑₛₑₜ 595a-d row-by-row, as described above. As another example, driver circuit module 600c may provide V_{row} 530c at VGL (e.g., −12 V) within scanning time 1005 until another time within scanning time 1005 when V_{row} 530c should be asserted, for example, by providing VGH (e.g., 15 V), and V_{row} 530 may then be deasserted to provide VGL again when V_{row} 530d should next be asserted within scanning time 1005. FIG. 9C is an illustration of another example of scanning time and idle time. In the example of FIG. 9C, time 1005c may be when V_{row} 530c is asserted. At times 1005a, b, and d, V_{row} 530 may not be asserted. Rather, V_{row} 530a, b, and d, respectively, may be asserted at those times. Accordingly, V_{row} 530c should be at a voltage (e.g., −12 V) such that the corresponding transistors T1 510 in row 705c are turned off except during time 1005c. That is, V_{row} 530c should be at a voltage to turn off transistors T1 510 in row 705c at times 1005a, b, d, and idle time 1010.

Additionally, idle time 1010 may be following scanning time 1005 when all driver circuit modules 600a-d deassert or hold V_{row} 530a-d to a voltage such that the corresponding transistors T1 510 are turned off and when driver circuit modules 600e-h hold Vᵣₑₛₑₜ 595a-d to a voltage such that the corresponding transistors T2 515 are turned off because each of the movable elements 570 is now at the proper position for the frame. That is, idle time 1010 may be the time between scanning times 1005 of consecutive frames in which driver circuit modules 600a-d and 600e-h do not assert signals (i.e., the signals are unasserted, or de-asserted), and therefore, the image on the display is stable (i.e., the state or positions of movable elements 570 are maintained).

In some implementations, driver circuit modules 600a-h providing V_{row} 530a-d and Vᵣₑₛₑₜ 595a-d for display modules 410 in rows 705a-d may be implemented with thin film transistors (TFTs) on glass substrates. Amorphous oxide semiconductor TFTs, such as indium gallium zinc oxide (IGZO) TFTs, may be used to replace amorphous silicon and low temperature and polysilicon TFTs. IGZO TFTs may have a high sub-threshold leakage current (e.g., an unwanted drain current when the transistor gate voltage is zero). Preferably, sub-threshold leakage current should be reduced to ensure a circuit operates properly and reduce static power consumption.

FIG. 6B is an illustration of example leakage currents of the driver circuit module of FIG. 6A. In FIG. 6B, VGLL may be a low voltage lower than VGL and VGH may be a high voltage higher than VGL. During idle time 1010 in FIGS. 9A and 9B, transistors M8 640, M7 635, M5 625, M21 645, and M20 650 (each circled in FIG. 6B) for every driver circuit modules 600a-h should be turned on to provide a voltage VGL (e.g., −12 V) at output 690, and therefore, every transistor T1 510 and T2 515 for every display module 410 in display 30 may be turned off because charge node Q 665 may be at VGLL (e.g., −15 V), which turns off transistors FB1 655, FB2 660, M4 620, and M6 630. However, sub-threshold leakage currents of turned-off transistors FB1 655, FB2 660, M4 620, and M6 630 may occur and contribute to static power consumption.

In some implementations, inputs may be gated, or configured to be floating or undriven, during idle time 1010 to reduce static power consumption. For example, regarding transistor FB1 655, since it is not needed to provide VGL at output 690 during idle time 1010, the power supply input VGH may be electrically disconnected from driver circuit module 600, and therefore, the VGH input to transistor FB1 655 may be floating, or undriven. That is, power supply input VGH may be provided to one terminal of a switch (e.g., implemented with a transistor) and the other terminal of the switch may be provided to the VGH input of driver circuit module 600. Driver circuit module 600 may be physically connected with the switch, but when the switch is turned off (e.g., when the transistor is turned off and in a non-conductive state), driver circuit module 600 may be electrically disconnected from the power supply input VGH (and therefore undriven). When the switch is turned on (e.g., when the transistor is turned on and in a conductive state), driver circuit module 600 may be electrically connected with power supply input VGH (and therefore be driven). As a result, during idle time 1010, any sub-threshold leakage current from transistor FB1 655 may not be able to draw current from the VGH voltage source, and therefore, static power consumption may be reduced. Likewise, inputs to transistors FB2 660 (i.e., also electrically disconnected from VGH), M4 620 (i.e., electrically disconnected from VGLL to prevent discharging of current from node QB 670), and M6 630 (i.e., electrically disconnected from CK) may also be configured to be floating during idle time 1010 (i.e., after scanning time 1005) to reduce static power consumption.

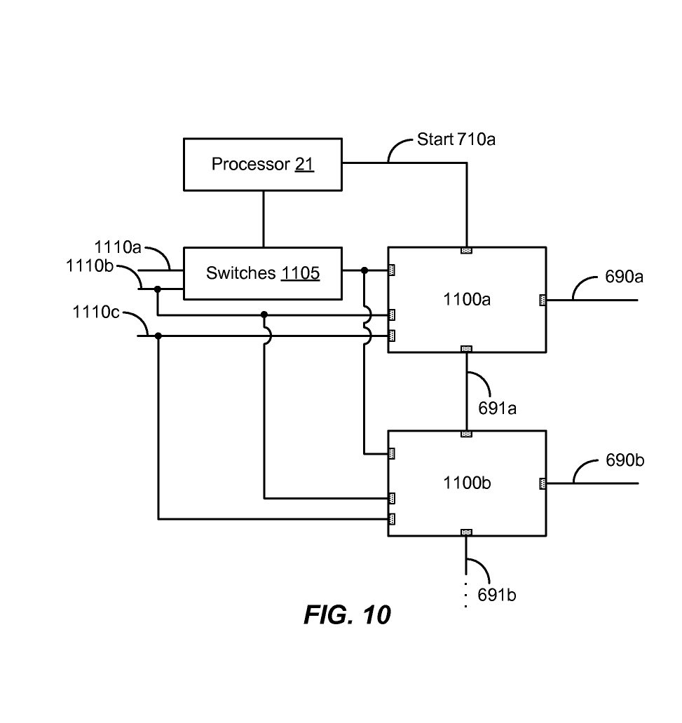

FIG. 10 is an example of a system block diagram of a driver circuit module with gated inputs to reduce static power consumption. In FIG. 10, inputs 1110a, 1110b, and 1110c may be inputs for driver circuit modules 1100a and 1100b. Driver circuit modules 1100a and 1100b may be used similar to driver circuit modules 600a-h in FIG. 7 to implement row select drivers providing V_{row} 530a-d and reset select drivers providing Vᵣₑₛₑₜ 595a-d. For example, if implementing a row select driver, then V_{row} 530a may be provided at output 690a and V_{row} 530b may be provided at output 690b. As another example, if implemented as a reset select driver, then Vᵣₑₛₑₜ 595a may be provided at output 690a and Vᵣₑₛₑₜ 595b may be provided at output 690b. As discussed later herein, driver circuit modules 1100a and 1100b may include design changes from driver circuit module 600 to further reduce static power consumption. However, in some implementations, driver circuit module 600 or other circuits may be used.

Inputs 1110a may be provided to driver circuit modules 1100a and 1100b through switches 1105. Switches 1105 may be configured by processor 21 to be turned off in an open or non-conductive state during idle time 1010 (and turned on in a closed or conducting state during scanning time 1005) such that some of the inputs to driver circuit modules 1100a and 1100b may become floating (e.g., some of the inputs of driver circuit module 1100a may be electrically disconnected from the sources that would otherwise be driving the inputs to circuit module 1100a with a voltage), and therefore, unable to draw leakage current from the source that would otherwise be connected and driving the input. Inputs 1110b may be split into two inputs to driver circuit modules 1100a and 1100b, one through switches 1105 to also be configured to be floating, while the other does not go through switches 1105. Inputs 1110c may not go through switches 1105 and are provided to driver circuit modules 1100a and 1100b.

In some implementations, processor 21 may determine when scanning time 1005 is done and/or idle time 1010 has started, and therefore, provide a signal to open or close switches 1105. For example, processor 21 may provide start 710a to driver circuit module 1100a to let the row select driver begin operation in scanning time, and then include a counter or other mechanism that may then assert the signal to open switches 1105 when scanning time 1005 should be finished. In other implementations, processor 21 may receive or monitor signals from the driver circuit modules and may be able to determine when scanning time 1005 is finished or idle time 1010 has begun. For example, processor 21 may open switches 1105 after V_{row} 530d in FIG. 7 has been asserted and then deasserted (i.e., the last row has been updated).

In some implementations, switches 1105 may be implemented in a chip-on-glass (COG) while driver circuit modules 1100a and 1100b may be implemented on the glass with TFTs. In some implementations, switches 1105 may be integrated with processor 21.

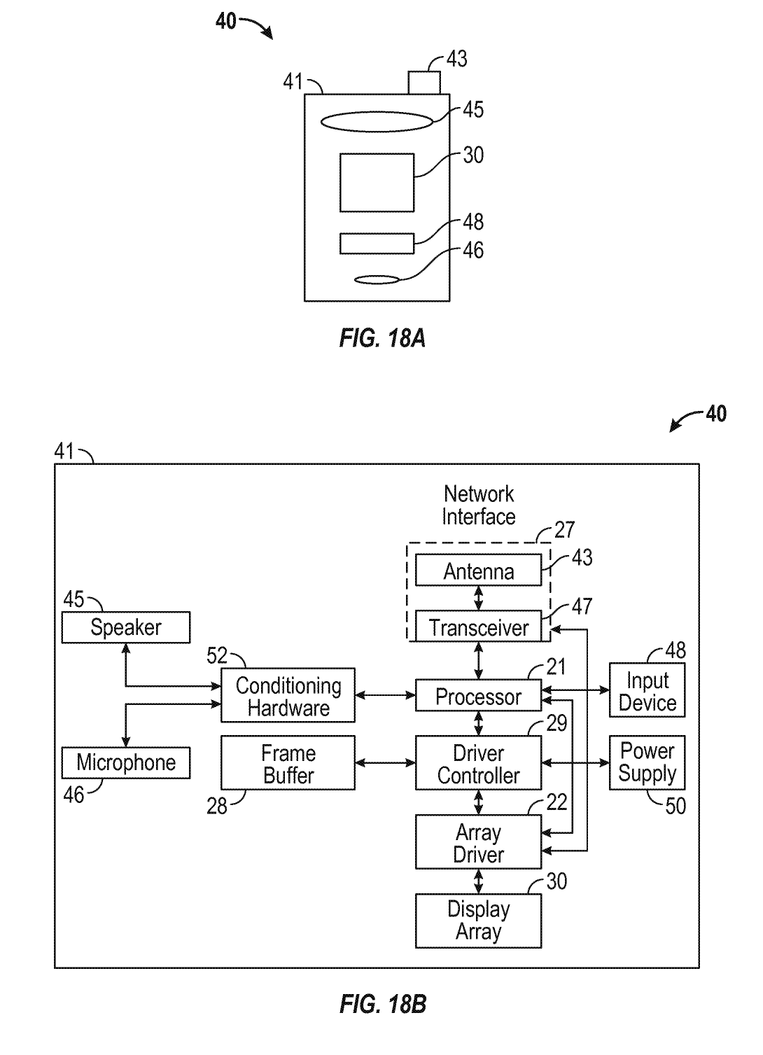

In some implementations, other types of circuitry may control switches 1105. For example, driver controller 29 in FIG. 18B may perform the operations of processor 21.

FIG. 11 is an example of a system block diagram of switches providing gated inputs to a driver circuit module. In FIG. 11, CKL1, CKL2, VGH, CK1, and CK2 may be included in inputs 1110a. VGLL may be included in inputs 1110b. VGL and BIASM may be included in inputs 1110c.

Accordingly, outputs CKL1 1210, CKL2 1215, VGH 1220, CK1 1225, and CK2 1230 from switches 1105 may be inputs to driver circuit modules 1100a and 1100b that can be configured to be floating to reduce static power consumption from sub-threshold leakage currents. VGLLp 1235 may be a gated version of the VGLL voltage source and VGLL 1240 may also be provided in a non-gated version as inputs to driver circuit modules 1100a and 1100b. BIASM 1250 and VGL 1245 are voltage sources that are not gated and are provided as inputs to driver circuit modules 1100a and 1100b. CKL1, CKL2, CK1, and CK2 may be clocks. The VGLL, BIASM, VGH, and VGL sources may be power supplies. The voltages provided by the power supplies may be in a decreasing order from VGH to VGLL: VGH (e.g., 16 V), BIASM (e.g., 1 V), VGL (e.g., −12 V), and VGLL (e.g., −15 V). Switches 1205a-f may be implemented with transistors, as previously discussed.

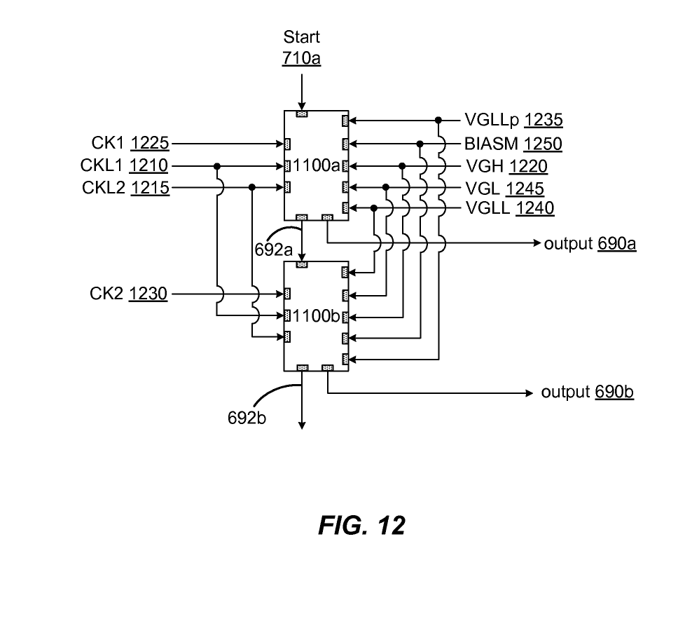

FIG. 12 is an example of a system block diagram of two driver circuit modules. In particular, FIG. 12 shows the interconnection of CKL1 1210, CKL2 1215, CK1 1225, CK2 1230, VGLLp 1235, VGLL 1240, BIASM 1250, VGH 1220, and VGL 1245 with two driver circuit modules 1100a and 1100b. Both driver circuit modules 1100a and 1100b include VGLLp 1235, VGLL 1240, BIASM 1250, VGH 1220, VGL 1245, CKL1 1210, and CKL2 1215 as inputs. However, CK1 1225 is provided as an input to driver circuit module 1100a and CK2 1225 is provided as an input to driver circuit module 1100b. Driver circuit modules 1100a and 1100b may provide V_{row} 530a and 530b at outputs 690a and 690b, respectively, if implemented as a row select driver and subsequent driver circuit modules not pictured in the example of FIG. 12 may provide other V_{row} 530 voltages. However, driver circuit modules 1100a and 1100b may instead provide Vᵣₑₛₑₜ 595a and 595b if implemented as a reset select driver, similar to the example in FIG. 7. Carry out 692a may be provided as the carry in 691b input. Carry out 692b may be provided as a carry in 691 input for a subsequent driver circuit module.

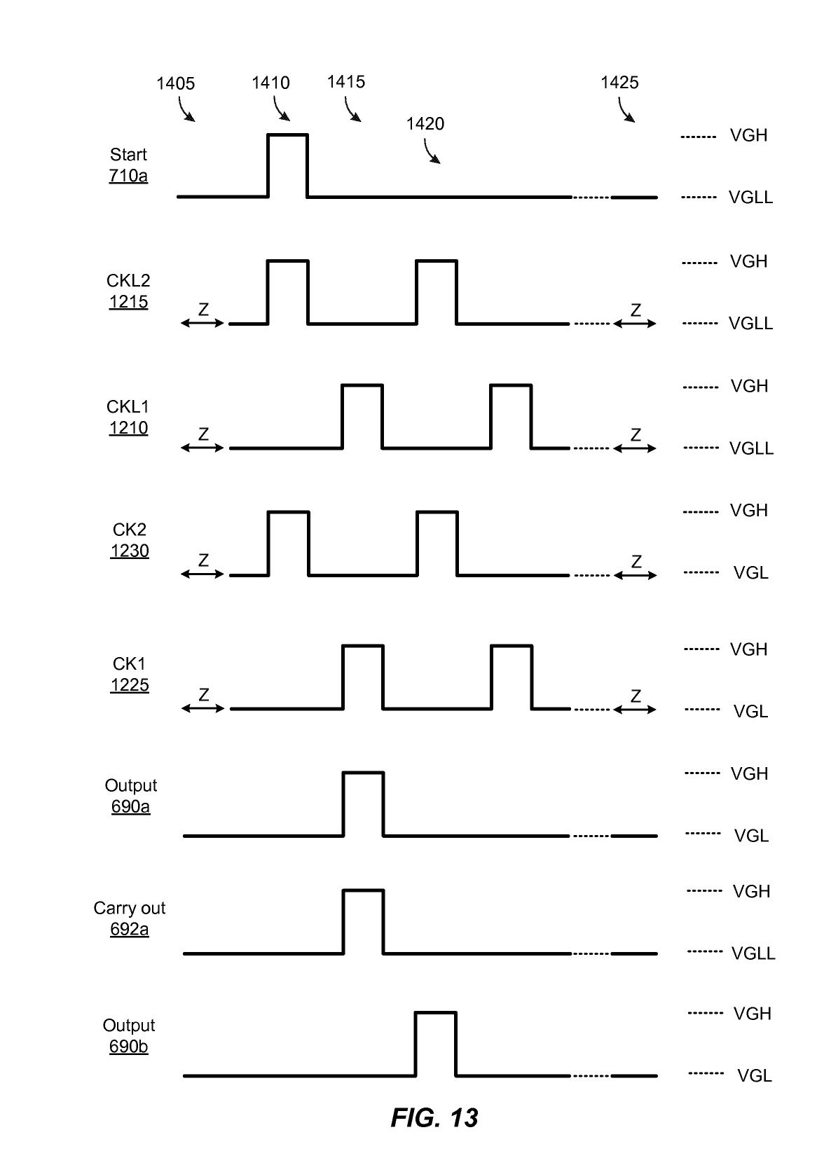

FIG. 13 is an example of a timing diagram for the driver circuit modules of FIG. 12. In FIG. 13, clocks CK1 1225 and CK2 1230 have a low voltage of VGL (e.g., −12 V) and a high voltage of VGH (e.g., 16 V). Clocks CKL1 1210 and CKL2 1215 have a low voltage of VGLL (e.g., −15 V or another voltage lower than VGL) and a high voltage of VGH. Outputs 690a and 690b have a low voltage of VGL and a high voltage of VGH. Output carry out 692a has a low voltage of VGLL and a high voltage of VGH.

Time 1405 in FIG. 13 may correspond with idle time 1010, and therefore, switches 1205a-f of switches 1105 in FIG. 11 may be opened, resulting in CKL2 1215, CKL1 1210, CK2 1230, and CK1 1225 floating, indicated as “Z” in FIG. 13. At time 1410, driver circuit modules 1100a and 1100b may now be in scanning time 1005 corresponding to a new frame, and therefore switches 1205a-f of switches 1105 may be closed, resulting in CKL2 1215, CKL1 1210, CK2 1230, and CK1 1225 no longer being floating, but driven by their respective sources as indicated by the toggling clocks. Also at time 1410, start 710a may be provided by processor 21 to driver circuit module 1100a at its carry in 691a input. At time 1415, output 690a (e.g., providing V_{row} 530a or Vᵣₑₛₑₜ 595a) may be asserted by driver circuit module 1100a. Additionally, carry out 692a may also be asserted and have a lower low voltage (i.e., VGLL) than output 690a. At time 1420, output 690a may no longer be asserted, but output 690b may be asserted by driver circuit module 1100a. Though not shown, carry out 692b may also be asserted and have a lower low voltage (i.e., VGLL) than output 690b. Eventually, at time 1425, scanning time 1005 may be finished and driver circuit modules 1100a and 1100b may be in idle time 1010. As a result, switches 1205a-f of switches 1105 may be opened again, resulting in CKL2 1215, CKL1 1210, CK2 1230, and CK1 1225 floating again, indicated as “Z” again in FIG. 13. Outputs 690a and 690b are at VGL at time 1425 because they should be deasserted during idle time 1010, as previously discussed. VGLLp 1235 and VGH 1220 may also be floating during times 1405 and 1425.

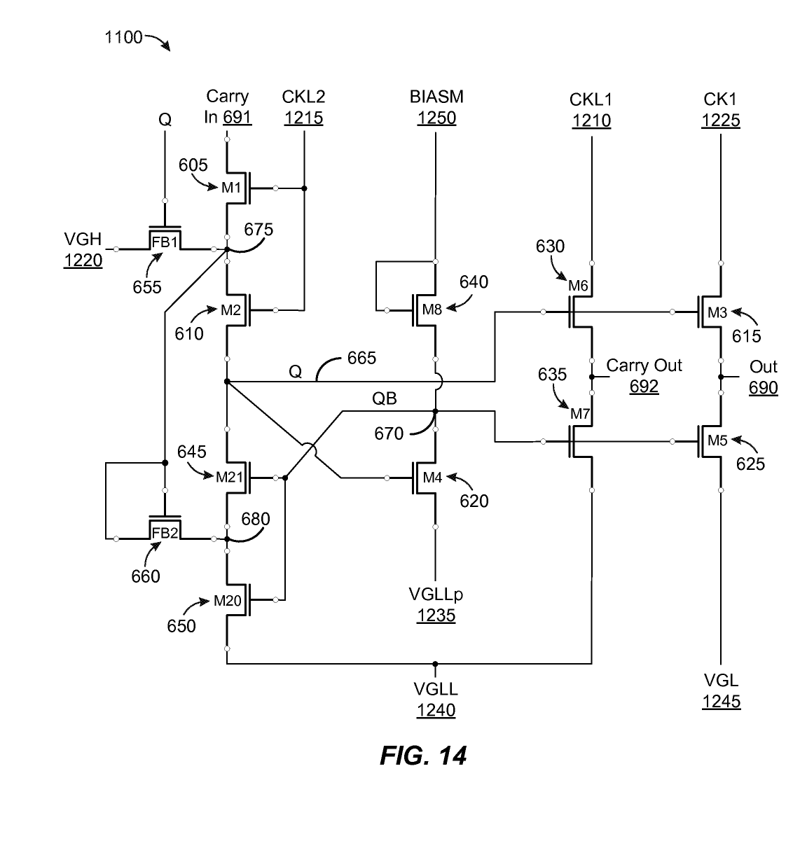

FIG. 14 is a circuit schematic of another example of a driver circuit module. Driver circuit module 1100 in FIG. 14 may be used for driver circuit modules 1100a and 1100b in FIGS. 10-13 and may also be implemented in FIGS. 7 and 8.

Driver circuit module 1100 includes a similar number of transistors as driver circuit module 600 in FIG. 6A and provides some similar functionality as discussed in U.S. patent application Publication Ser. No. 13/909,839, titled REDUCING FLOATING NODE LEAKAGE CURRENT WITH A FEEDBACK TRANSISTOR, by Kim et al., filed on Jun. 4, 2013, as referenced in regards to FIG. 6A. Though shown implemented with NMOS transistors as switches, in other implementations, driver circuit module 1100 may be implemented with PMOS transistors or other types of transistors or components.

As with FIG. 6A, transistors M21 645, M20 650, M8 640, M7 635, and M5 625 may be turned on to have output 690 at VGL and carry out 692 at VGLL (i.e., have output 690 unasserted, or de-asserted). To have output 690 be asserted by providing VGH, transistors M1 605, M2 610, M6 630, M3 615, FB1 655, and FB2 660 may be used.

As previously discussed, CKL2 1215, CKL1 1210, CK1 1225, VGH 1220, and VGLLp 1235 may be floating inputs to driver circuit module 1100 when switches 1205a-f are turned off during idle time 1010 (e.g., during times 1405 and 1425 in FIG. 13). As a result, sub-threshold leakage currents may not be able to draw from the electrically disconnected sources, and therefore, static power consumption may be reduced. For example, feedback transistor FB1 655 may be turned off during idle time 1010 and VGH 1220 may be floating because switch 1205c may be opened. As a result, sub-threshold leakage current of feedback transistor FB 655 may be reduced because it may not be able to draw from the electrically disconnected voltage source providing VGH. Likewise, VGLLp 1235 may be floating when switch 1205f is opened, and therefore, sub-threshold leakage current may not discharge node QB 670 through VGLLp 1235. Additionally, splitting the VGLL power supply into VGLLp 1235 and VGLL 1240 may allow for transistor M4 620 to have a floating power supply input while transistors M20 650 and M7 635 are still coupled with VGLL 1240 to be driven by the VGLL power supply when VGLLp 1235 is floating.

Floating the clock and power supply inputs of transistors unnecessary for providing VGL at output 690 in driver circuit module 1100 during idle time 1010 to reduce static power consumption may provide lower power requirements for a display device. In some implementations, the longer idle time 1010 is the more significant the reduction in static power consumption may be. For example, at a 1 Hz refresh rate (i.e., the example in FIG. 9B), idle time 1010 is longer than in 60 Hz (i.e., the example in FIG. 9A), and therefore power requirements may lower, particularly as Vₒₙ is decreased to further negative voltages.

Driver circuit module 1100 in FIG. 14 may be implemented to provide driver circuit module 1100a using clocks CKL2 1215 provided to the gates of transistors M1 605 and M2 610, CKL1 1210 provided to transistor M6 630, and CK1 1225 provided to transistor M3 615. If implementing driver circuit module 1100b, different clocks may be provided to different transistors, for example, CKL1 1210 may be provided to the gates of transistors M1 605 and M2 610, CKL2 1215 may be provided to transistor M6 630, and CK2 1230 may be provided to transistor M3 615. A third driver circuit module may utilize the configuration of clocks as driver circuit module 1100a, a fourth driver circuit module may utilize the configuration of clocks as driver circuit module 1100b, and so on such that consecutive stages switch between the different configurations for the clocks. Accordingly, the pair of driver circuit modules 1100a and 1100b in FIG. 12 may represent two consecutive stages with different sets of clock inputs.

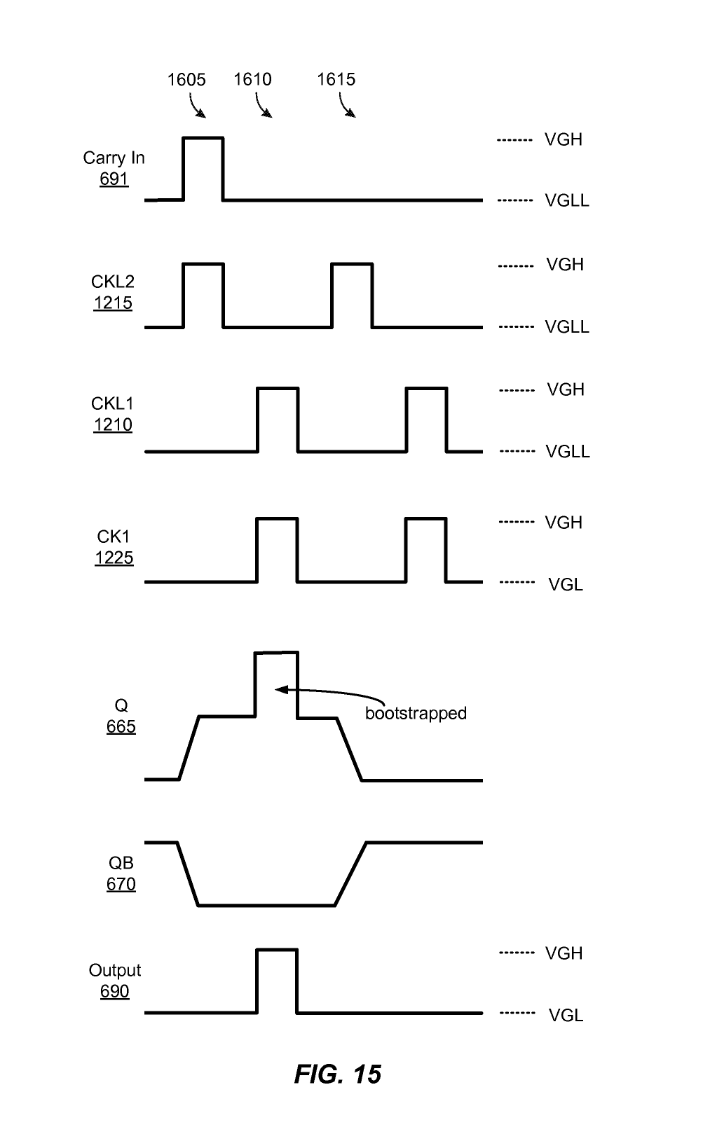

FIG. 15 is an example of a timing diagram for the driver circuit module of FIG. 14. The timing diagram includes the signals for carry in 691, CKL2 1215, CKL1 1210, CK1 1225, internal nodes charge node Q 665 and node QB 670, and output 690. CKL1 1210 and CK1 1225 may both have the same timing characteristics (e.g., same frequency and phase), but CKL1 1210 may have a lower low voltage of VGLL (e.g., −15 V) rather than VGL (e.g., −12 V). CKL2 1215 may be out of phase with CKL1 1210 and CK1 1225 and have a low voltage of VGLL. Each of CKL1 1210, CKL2 1215, and CK1 1225 may have a high voltage of VGH (e.g., 16 V).

In FIG. 15, at time 1605, carry in 691 (e.g., provided by start 710a, or output carry out 692 of another driver circuit module) is high, CKL2 1215 is high, and both CKL1 1210 and CK1 1225 are low. Accordingly, transistors M1 605 and M2 610 in FIG. 14 turn on because CKL2 1215 is coupled with their gate terminals, and therefore, charge node Q 665 goes high because carry in 691 is high when the transistors are turned on. Because charge node Q 665 is high, transistors M6 630 and M3 615 are turned on because charge node Q 665 is coupled with their gate terminals. QB node 670 is low because when charge node Q 665 is high, transistor M4 620 turns on and pulls QB node 670 to VGLLp 1235 (e.g., −15 V).

At time 1610, carry in 691 is low, CKL2 1215 is low, CKL1 1210 is high and CK1 1225 is high. As a result, transistors M1 605 and M2 610 are off because CKL2 1215 is low and coupled to their gate terminals, and therefore, transistor M2 610 is no longer driving charge node Q 665. Since node QB 670 is also low, transistors M21 645 and M20 650 are also off and also not driving charge node QB 665, for example to VGLL. Accordingly, charge node Q 665 is no longer being driven, and therefore, is floating (i.e., not being pulled high or low). Transistors M6 630 and M3 615 remain turned on because charge node Q 665 is still charged high even though it is floating. Accordingly, output 690 follows CK1 1225 and carry out 692 (not shown in FIG. 15) follows CKL 1210.

Similar with the circuit of FIG. 6A, capacitive coupling between CKL1 1210 and/or CK1 1225 through the gates of transistors M6 630 and M3 615, respectively, with charge node Q 665 may cause charge node Q 665 to “bootstrap,” or experience a boosting voltage, because undriven or floating nodes may be more susceptible to capacitive coupling. Accordingly, the voltage at charge node Q 665 may be stepped up beyond the level set by the previous clock cycle, as indicated by the bootstrap label in FIG. 15.

At time 1615, carry in 691 is low, CKL2 1215 is high, CKL1 1210 is low, and CK1 1225 is low. Accordingly, charge node Q 665 is discharged low due to transistors M1 605 and M2 610 turning on when CKL2 1215 goes high, turning off transistors M6 630, M3 615, and M4 620. Transistor M8 640 is on, causing node QB 670 to be at BIASM, which is a higher voltage level than VGL (e.g., VGL may be 0 V and BIASM may be higher than 0 V), turning on transistors M21 645, M20 650, M7 635, and M5 625, resulting in carry out 692 and output 690 at VGLL and VGL, respectively. Carry out 692 and output 690 may stay at VGLL and VGL, respectively, until they should be asserted next within the next scanning time 1005.

Accordingly, to assert output 690 by providing VGH, a set of transistors including transistors M1 605, M2 610, M4 620, M6 630, and M3 615 are needed. The set of transistors may also include feedback transistors FB1 655 and FB2 660 to reduce leakage from charge node Q 665 during the bootstrap phase used to provide VGH at output 690. To provide VGL at output 690, a set of transistors including transistors M8 640, M21 645, M20 650, M7 635, and M5 625 are needed. Therefore, as previously discussed, inputs to the unneeded transistors when output 690 is at VGL may be electrically disconnected by switches 1105 during idle time 1010 as they are not used to provide VGL at output 690.

Additionally, by contrast to driver circuit module 600 in FIG. 6A, design changes in driver circuit module 1100 in FIG. 14 incorporate additional clock signals that may be used to further reduce sub-threshold leakage currents to reduce static power consumption. In some implementations, sub-threshold leakage in driver circuit module 1100 may also be reduced, for example, during scanning time 1005 when inputs are not floating. For example, V_{gs} of some transistors may be reduced to lower sub-threshold leakage by having CKL1 1210 and CKL2 1215 having a low voltage of VGLL rather than VGL. Additionally, the configuration of feedback transistors FB1 655 and FB2 660 may also be changed to further reduce sub-threshold leakage current.

At time 1615, when carry out 692 is pulled to VGLL by transistor M7 635, output 690 is pulled to VGL by transistor M5 625, charge node Q 665 goes low, and node QB 670 goes to BIASM, sub-threshold leakage current at transistors M6 630, M1 605, M2 610, M21 645, and M20 650 may be experienced. The sub-threshold leakage current may be reduced by lowering the V_{gs} of the transistors by having CKL1 1210 and CKL2 1215 having a low voltage of VGLL rather than VGL and the configuration of feedback transistors FB1 655 and FB2 660.

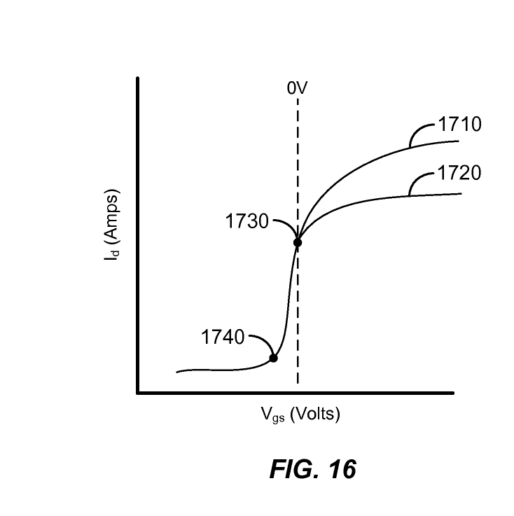

FIG. 16 is an illustration of a transfer curve for I_{d} (drain current) vs. V_{gs} (gate-to-source voltage) for an exemplary NMOS transistor. In FIG. 16, curves 1710 and 1720 may represent two different V_{ds} (drain-to-source voltage) biases. For example, curve 1710 may be associated with a V_{ds} of 10.1 V (Volts) and curve 1720 may be associated with a V_{ds} of 0.1 V.

As seen in FIG. 16, I_{d} is lower at lower V_{gs} values. Some transistors, such as depletion mode field effect transistors, show a negative turn-on voltage (Vₒₙ) which is the V_{gs} where I_{d} starts to increase abruptly with increasing V_{gs}. For example, in FIG. 16, point 1740 may be associated with a Vₒₙ of −1 V. Moreover, at point 1730, or a 0 V V_{gs} bias, I_{d} may approximately be 1 nA (nanoampere) or higher.

Ideally, when V_{gs}<Vₜₕ (threshold voltage), such as at point 1730 when V_{gs} is 0 V, an NMOS transistor should be turned off, and thus I_{d} should be 0 A. However, a sub-threshold leakage occurs, as indicated by the non-zero y-axis I_{d} of points 1730 and 1740 on the transfer curves of FIG. 16. The sub-threshold leakage may increase power consumption and/or interfere with the intended operation of a circuit.

Accordingly, biasing the V_{gs} of an NMOS transistor lower may reduce the sub-threshold leakage. That is, biasing V_{gs} at point 1740, or any lower V_{gs} value, rather than point 1730 at 0 V V_{gs}, reduces the I_{d} sub-threshold leakage.

The voltage selection scheme in driver circuit module 1100 in FIG. 10 may provide a lower V_{gs} value for transistors to reduce sub-threshold leakage. In particular, since CKL1 1210 and CKL2 1215 have a low voltage of VGLL rather than VGL, the V_{gs} of transistors M6 630, M1 605, and M2 610 can be lowered to reduce static power consumption. For example, V_{gs} for transistor M1 605 may be lower when CKL2 1215 goes low to VGLL rather than VGL. Likewise, V_{gs} for transistors M2 610 and M6 1230 may also be lowered to reduce sub-threshold leakage.

Additionally, sub-threshold leakage current may be reduced with feedback transistors FB1 665 and FB2 660 that may otherwise discharge charge node Q 665. In particular, when charge node Q 665 is floating and bootstrapped, leakage at transistors M2 610 and M21 645 may discharge charge node Q665, lowering its voltage to a lower than expected voltage or enter an intermediate voltage state. Feedback transistors FB1 665 and FB2 660 may be used to lower the V_{gs} of transistors M2 610 and M21 645, respectively, and therefore, reduce leakage current contributing to the discharge of charge node Q 665. By contrast to FIG. 6A, feedback transistors FB1 665 and FB2 660 include a different configuration to further reduce static power consumption that may lead to discharging charge node Q 665.

In FIG. 14, feedback transistor FB1 655, transistor M1 605, and transistor M2 610 are coupled together to define feedback node 675. Likewise, feedback transistor FB2 660, transistor M21 645, and M20 650 are coupled together to define feedback node 680. The gate of feedback transistor FB1 655 is coupled with charge node Q 665. The gate of feedback transistor FB2 660 is coupled with feedback node 675. Additionally, another terminal of feedback transistor FB2 660 is also coupled with feedback node 675 such that feedback transistor FB2 is configured as a diode-connected transistor to provide functionality similar to a diode. In particular, feedback transistor FB2 660 may provide a voltage at feedback node 680 based on the voltage at feedback node 675 with a voltage drop. That is, the voltage at feedback node 680 may be slightly lower than the voltage at feedback node 675 due to feedback transistor FB2 660.

Accordingly, when charge node Q 665 goes high and into the bootstrap, feedback transistor FB1 655 turns on. Feedback node 675 may then go high because the drain of feedback transistor FB1 655 is coupled with VGH (i.e., the high voltage). The gate to transistor M2 610 is coupled to receive CKL2 1215, which is low at VGLL during the bootstrap phase. Therefore, transistor M2 610 is turned off. As such, transistor M2 610's V_{gs} may be lower with CKL2 having a low voltage of VGLL rather than VGL. The V_{gs} of transistor M21 645 may also be lower than the configuration in FIG. 6A because the voltage at feedback node 680 may be provided a voltage lower than the voltage at feedback node 675 with the diode-connected configuration of feedback transistor FB2 660 coupled with feedback node 680. As a result, sub-threshold leakage through turned-off transistors M2 610 and M21 645 may be reduced.

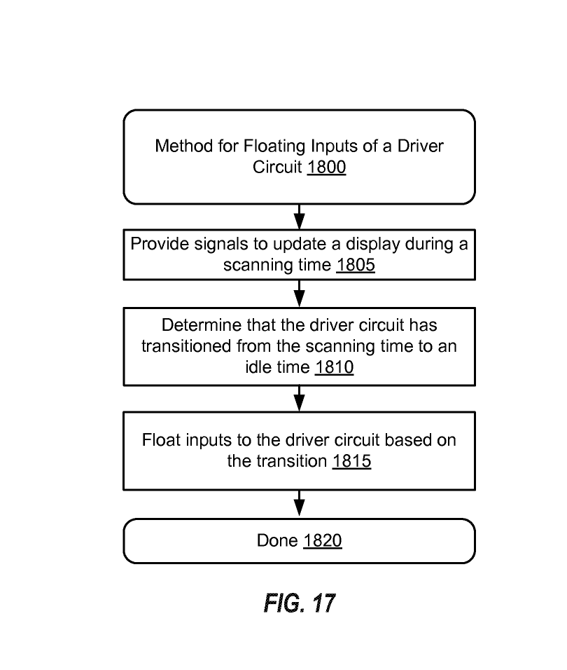

FIG. 17 is a flow diagram illustrating a method for floating inputs of a driver circuit. In method 1800, at block 1805, a driver circuit may provide signals to update a display during a scanning time. For example, outputs 690 of driver circuit modules may be asserted. At block 1810, a controller may determine that the driver circuit has transitioned from the scanning time to an idle time. At block 1815, inputs to the driver circuit may be floated. For example, the inputs may be electrically disconnected from sources that would otherwise be driving the inputs. The method ends at block 1820.

FIGS. 18A and 18B are system block diagrams illustrating a display device 40 that includes a plurality of IMOD display elements. The display device 40 can be, for example, a smart phone, a cellular or mobile telephone. However, the same components of the display device 40 or slight variations thereof are also illustrative of various types of display devices such as televisions, computers, tablets, e-readers, hand-held devices and portable media devices.

The display device 40 includes a housing 41, a display 30, an antenna 43, a speaker 45, an input device 48 and a microphone 46. The housing 41 can be formed from any of a variety of manufacturing processes, including injection molding, and vacuum forming. In addition, the housing 41 may be made from any of a variety of materials, including, but not limited to: plastic, metal, glass, rubber and ceramic, or a combination thereof. The housing 41 can include removable portions (not shown) that may be interchanged with other removable portions of different color, or containing different logos, pictures, or symbols.

The display 30 may be any of a variety of displays, including a bi-stable or analog display, as described herein. The display 30 also can be configured to include a flat-panel display, such as plasma, EL, OLED, STN LCD, or TFT LCD, or a non-flat-panel display, such as a CRT or other tube device. In addition, the display 30 can include an IMOD-based display, as described herein.

The components of the display device 40 are schematically illustrated in FIG. 18A. The display device 40 includes a housing 41 and can include additional components at least partially enclosed therein. For example, the display device 40 includes a network interface 27 that includes an antenna 43 which can be coupled to a transceiver 47. The network interface 27 may be a source for image data that could be displayed on the display device 40. Accordingly, the network interface 27 is one example of an image source module, but the processor 21 and the input device 48 also may serve as an image source module. The transceiver 47 is connected to a processor 21, which is connected to conditioning hardware 52. The conditioning hardware 52 may be configured to condition a signal (such as filter or otherwise manipulate a signal). The conditioning hardware 52 can be connected to a speaker 45 and a microphone 46. The processor 21 also can be connected to an input device 48 and a driver controller 29. The driver controller 29 can be coupled to a frame buffer 28, and to an array driver 22, which in turn can be coupled to a display array 30. One or more elements in the display device 40, including elements not specifically depicted in FIG. 18A, can be configured to function as a memory device and be configured to communicate with the processor 21. In some implementations, a power supply 50 can provide power to substantially all components in the particular display device 40 design.

The network interface 27 includes the antenna 43 and the transceiver 47 so that the display device 40 can communicate with one or more devices over a network. The network interface 27 also may have some processing capabilities to relieve, for example, data processing requirements of the processor 21. The antenna 43 can transmit and receive signals. In some implementations, the antenna 43 transmits and receives RF signals according to the IEEE 16.11 standard, including IEEE 16.11(a), (b), or (g), or the IEEE 802.11 standard, including IEEE 802.11a, b, g, n, and further implementations thereof. In some other implementations, the antenna 43 transmits and receives RF signals according to the Bluetooth® standard. In the case of a cellular telephone, the antenna 43 can be designed to receive code division multiple access (CDMA), frequency division multiple access (FDMA), time division multiple access (TDMA), Global System for Mobile communications (GSM), GSM/General Packet Radio Service (GPRS), Enhanced Data GSM Environment (EDGE), Terrestrial Trunked Radio (TETRA), Wideband-CDMA (W-CDMA), Evolution Data Optimized (EV-DO), 1×EV-DO, EV-DO Rev A, EV-DO Rev B, High Speed Packet Access (HSPA), High Speed Downlink Packet Access (HSDPA), High Speed Uplink Packet Access (HSUPA), Evolved High Speed Packet Access (HSPA+), Long Term Evolution (LTE), AMPS, or other known signals that are used to communicate within a wireless network, such as a system utilizing 3G, 4G or 5G technology. The transceiver 47 can pre-process the signals received from the antenna 43 so that they may be received by and further manipulated by the processor 21. The transceiver 47 also can process signals received from the processor 21 so that they may be transmitted from the display device 40 via the antenna 43.

In some implementations, the transceiver 47 can be replaced by a receiver. In addition, in some implementations, the network interface 27 can be replaced by an image source, which can store or generate image data to be sent to the processor 21. The processor 21 can control the overall operation of the display device 40. The processor 21 receives data, such as compressed image data from the network interface 27 or an image source, and processes the data into raw image data or into a format that can be readily processed into raw image data. The processor 21 can send the processed data to the driver controller 29 or to the frame buffer 28 for storage. Raw data typically refers to the information that identifies the image characteristics at each location within an image. For example, such image characteristics can include color, saturation and gray-scale level.

The processor 21 can include a microcontroller, CPU, or logic unit to control operation of the display device 40. The conditioning hardware 52 may include amplifiers and filters for transmitting signals to the speaker 45, and for receiving signals from the microphone 46. The conditioning hardware 52 may be discrete components within the display device 40, or may be incorporated within the processor 21 or other components.

The driver controller 29 can take the raw image data generated by the processor 21 either directly from the processor 21 or from the frame buffer 28 and can re-format the raw image data appropriately for high speed transmission to the array driver 22. In some implementations, the driver controller 29 can re-format the raw image data into a data flow having a raster-like format, such that it has a time order suitable for scanning across the display array 30. Then the driver controller 29 sends the formatted information to the array driver 22. Although a driver controller 29, such as an LCD controller, is often associated with the system processor 21 as a stand-alone Integrated Circuit (IC), such controllers may be implemented in many ways. For example, controllers may be embedded in the processor 21 as hardware, embedded in the processor 21 as software, or fully integrated in hardware with the array driver 22.

The array driver 22 can receive the formatted information from the driver controller 29 and can re-format the video data into a parallel set of waveforms that are applied many times per second to the hundreds, and sometimes thousands (or more), of leads coming from the display's x-y matrix of display elements.

In some implementations, the driver controller 29, the array driver 22, and the display array 30 are appropriate for any of the types of displays described herein. For example, the driver controller 29 can be a conventional display controller or a bi-stable display controller (such as an IMOD display element controller). Additionally, the array driver 22 can be a conventional driver or a bi-stable display driver (such as an IMOD display element driver). Moreover, the display array 30 can be a conventional display array or a bi-stable display array (such as a display including an array of IMOD display elements). In some implementations, the driver controller 29 can be integrated with the array driver 22. Such an implementation can be useful in highly integrated systems, for example, mobile phones, portable-electronic devices, watches or small-area displays.

In some implementations, the input device 48 can be configured to allow, for example, a user to control the operation of the display device 40. The input device 48 can include a keypad, such as a QWERTY keyboard or a telephone keypad, a button, a switch, a rocker, a touch-sensitive screen, a touch-sensitive screen integrated with the display array 30, or a pressure- or heat-sensitive membrane. The microphone 46 can be configured as an input device for the display device 40. In some implementations, voice commands through the microphone 46 can be used for controlling operations of the display device 40.

The power supply 50 can include a variety of energy storage devices. For example, the power supply 50 can be a rechargeable battery, such as a nickel-cadmium battery or a lithium-ion battery. In implementations using a rechargeable battery, the rechargeable battery may be chargeable using power coming from, for example, a wall socket or a photovoltaic device or array. Alternatively, the rechargeable battery can be wirelessly chargeable. The power supply 50 also can be a renewable energy source, a capacitor, or a solar cell, including a plastic solar cell or solar-cell paint. The power supply 50 also can be configured to receive power from a wall outlet.

In some implementations, control programmability resides in the driver controller 29 which can be located in several places in the electronic display system. In some other implementations, control programmability resides in the array driver 22. The above-described optimization may be implemented in any number of hardware and/or software components and in various configurations.

As used herein, a phrase referring to “at least one of” a list of items refers to any combination of those items, including single members. As an example, “at least one of: a, b, or c” is intended to cover: a, b, c, a-b, a-c, b-c, and a-b-c.

The various illustrative logics, logical blocks, modules, circuits and algorithm steps described in connection with the implementations disclosed herein may be implemented as electronic hardware, computer software, or combinations of both. The interchangeability of hardware and software has been described generally, in terms of functionality, and illustrated in the various illustrative components, blocks, modules, circuits and steps described above. Whether such functionality is implemented in hardware or software depends upon the particular application and design constraints imposed on the overall system.

The hardware and data processing apparatus used to implement the various illustrative logics, logical blocks, modules and circuits described in connection with the aspects disclosed herein may be implemented or performed with a general purpose single- or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, or, any conventional processor, controller, microcontroller, or state machine. A processor also may be implemented as a combination of computing devices, such as a combination of a DSP and a microprocessor, a plurality of microprocessors, one or more microprocessors in conjunction with a DSP core, or any other such configuration. In some implementations, particular steps and methods may be performed by circuitry that is specific to a given function.

In one or more aspects, the functions described may be implemented in hardware, digital electronic circuitry, computer software, firmware, including the structures disclosed in this specification and their structural equivalents thereof, or in any combination thereof. Implementations of the subject matter described in this specification also can be implemented as one or more computer programs, i.e., one or more modules of computer program instructions, encoded on a computer storage media for execution by, or to control the operation of, data processing apparatus.

If implemented in software, the functions may be stored on or transmitted over as one or more instructions or code on a computer-readable medium. The steps of a method or algorithm disclosed herein may be implemented in a processor-executable software module which may reside on a computer-readable medium. Computer-readable media includes both computer storage media and communication media including any medium that can be enabled to transfer a computer program from one place to another. A storage media may be any available media that may be accessed by a computer. By way of example, and not limitation, such computer-readable media may include RAM, ROM, EEPROM, CD-ROM or other optical disk storage, magnetic disk storage or other magnetic storage devices, or any other medium that may be used to store desired program code in the form of instructions or data structures and that may be accessed by a computer. Also, any connection can be properly termed a computer-readable medium. Disk and disc, as used herein, includes compact disc (CD), laser disc, optical disc, digital versatile disc (DVD), floppy disk, and blu-ray disc where disks usually reproduce data magnetically, while discs reproduce data optically with lasers. Combinations of the above also may be included within the scope of computer-readable media. Additionally, the operations of a method or algorithm may reside as one or any combination or set of codes and instructions on a machine readable medium and computer-readable medium, which may be incorporated into a computer program product.

Various modifications to the implementations described in this disclosure may be readily apparent to those skilled in the art, and the generic principles defined herein may be applied to other implementations without departing from the spirit or scope of this disclosure. Thus, the claims are not intended to be limited to the implementations shown herein, but are to be accorded the widest scope consistent with this disclosure, the principles and the novel features disclosed herein. Additionally, a person having ordinary skill in the art will readily appreciate, the terms “upper” and “lower” are sometimes used for ease of describing the figures, and indicate relative positions corresponding to the orientation of the figure on a properly oriented page, and may not reflect the proper orientation of, e.g., an IMOD display element as implemented.

Certain features that are described in this specification in the context of separate implementations also can be implemented in combination in a single implementation. Conversely, various features that are described in the context of a single implementation also can be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, a person having ordinary skill in the art will readily recognize that such operations need not be performed in the particular order shown or in sequential order, or that all illustrated operations be performed, to achieve desirable results. Further, the drawings may schematically depict one more example processes in the form of a flow diagram. However, other operations that are not depicted can be incorporated in the example processes that are schematically illustrated. For example, one or more additional operations can be performed before, after, simultaneously, or between any of the illustrated operations. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products. Additionally, other implementations are within the scope of the following claims. In some cases, the actions recited in the claims can be performed in a different order and still achieve desirable results.

What is claimed is:

1. A circuit comprising:
a driver circuit including driver circuit modules capable of asserting signals to update an array of display units during a first scanning time, and the driver circuit modules being in an idle state during an idle time following the first scanning time; and
a controller capable of electrically disconnecting a first set of inputs of the driver circuit modules from one or more sources, the disconnecting based on the driver circuit modules being in the idle state.

2. The circuit of claim 1, wherein the idle time corresponds to a time after the first scanning time and before a second scanning time, the signals de-asserted during the idle time, the signals asserted during the first scanning time and the second scanning time.

3. The circuit of claim 1, wherein each driver circuit module includes a first set of transistors associated with the first set of inputs and a second set of transistors associated with a second set of inputs, the controller capable of electrically disconnecting the first set of inputs from one or more of the sources during the idle state, and electrically connecting the second set of inputs to one or more of the sources during the idle state.

4. The circuit of claim 3, wherein the first set of transistors is capable of asserting the signals during the first scanning time, and the second set of transistors is capable of having the signals de-asserted during the idle state.

5. The circuit of claim 3, wherein a first transistor in the first set of transistors has a first input, a second transistor in the second set of transistors has a second input, the first input and the second input capable of being electrically connected with a first source during the scanning time, the first input of the first transistor capable of being electrically disconnected from the first source in the idle state, and the second input of the second transistor capable of remaining electrically coupled with the first source in the idle state.

6. The circuit of claim 1, wherein the sources include a clock source and a power supply source.

7. The circuit of claim 6, wherein the first set of inputs is electrically disconnected from the clock source during the idle state.

8. The circuit of claim 1, wherein each driver circuit module includes:
a first input switch including:
a first switch having a first terminal and a second terminal, the first terminal of the first switch coupled to receive an input signal, and
a second switch having a first terminal and a second terminal, the first terminal of the second switch coupled with the second terminal of the first switch to define a first feedback node;
a first output switch including a third switch having a control terminal coupled with the second terminal of the second switch to define a charge node;
a first feedback switch having a first terminal and a control terminal, the first terminal of the first feedback switch coupled with the first feedback node, the control terminal of the first feedback switch coupled with the charge node, the feedback switch configured to charge the first feedback node responsive to a voltage level at the charge node;
a second feedback switch having a first terminal, a second terminal, and a control terminal, the control terminal and the first terminal of the second feedback switch coupled with the first feedback node; and
a fourth switch having a first terminal and a second terminal, the first terminal of the fourth switch coupled with the charge node, the second terminal of the fourth switch coupled with the second terminal of the second feedback switch to define a second feedback node, the second feedback switch configured to charge the second feedback node responsive to a voltage at the first feedback node.

9. The circuit of claim 1, wherein the driver circuit includes a first driver circuit module and a second driver circuit module, the first driver circuit module coupled with a first clock source, a second clock source, and a third clock source, the second driver circuit module coupled with the first clock source, the second clock source, and a fourth clock source, the clock sources being electrically disconnected from driver circuit modules the during the idle state.

10. The circuit of claim 9, wherein a voltage corresponding to a low state of the first clock source and the second clock source is lower than a voltage corresponding to a low state of the third clock source.

11. The circuit of claim 1, further comprising:
a display including the array of display units;
a processor that is configured to communicate with the display, the processor being configured to process image data; and
a memory device that is configured to communicate with the processor.

12. The circuit of claim 11, further comprising:
a controller configured to send at least a portion of the image data to the driver circuit.

13. The circuit of claim 11, further comprising:
an image source module configured to send the image data to the processor, wherein the image source module comprises at least one of a receiver, transceiver, and transmitter.

14. The circuit of claim 11, further comprising:
an input device configured to receive input data and to communicate the input data to the processor.

15. A system including:
a driver circuit capable of updating a state of display elements in a display during a first scanning time and maintaining the state of the display elements during an idle time, the idle time occurring after the first scanning time; and
a controller capable of determining that the driver circuit is in the idle time, and floating inputs of the driver circuit associated with updating the state of the display elements responsive to the determination that the driver circuit is in the idle time.

16. The system of claim 15, wherein the controller is further capable of having the floating inputs be driven for a second scanning time for updating the state of the display elements in the display.

17. The system of claim 15, wherein inputs of the driver circuit associated with maintaining the state of the display elements are driven during the idle time.

18. The system of claim 17, wherein the inputs of the driver circuit associated with maintaining the state of the display elements are coupled with power supplies during the idle time.

19. A method comprising:
providing, by a driver circuit, signals to update a display during a scanning time;
determining, by a controller, that the driver circuit has transitioned from the scanning time to an idle time; and
floating, by the controller, inputs to the driver circuit based on the transition from the scanning time to the idle time.

20. The method of claim 19, wherein the signals are asserted to update the display during the scanning time, and the signals are all de-asserted during the idle time.
